(19) United States
(12) Patent Application Publication
(10) Pub. No.: US 2006/0003824 A1
(43) Pub. Date: Jan. 5, 2006

(54) Game system

(75) Inventors: Takahiko Kobayashi, Tokyo (JP); Junichi Kogo, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 11/171,601

(22) Filed: Jul. 1, 2005

(30) Foreign Application Priority Data
Jul. 1, 2004 (JP) 2004-196032
Nov. 29, 2004 (JP) 2004-344679

(51) Int. Cl. A63F 13/00

(52) U.S. Cl. 463/1; 463/42

(57) ABSTRACT

A game system has an image display control unit, a selection unit, a message input unit, and a message transmission unit. The image display control unit causes a display unit, which is provided to each of terminal devices, to display a game image including characters. The selection unit selects, according to an operation of a player, any one of characters corresponding to other players than the player, who performs the operation, from among the characters included in the game image. The message input unit inputs a message according to an operation of the player. The message transmission unit transmits the message inputted by the message input unit to a terminal device used by a player who operates the character selected by the selection unit.

### CROSS REFERENCE TO RELATED APPLICATION

This application is based upon and claims the benefit of priority from the prior Japanese Patent Applications No. 2004-196032, filed on Jul. 1, 2004 and No. 2004-344679, filed on Nov. 29, 2004, the entire contents of which are incorporated herein by reference.

This application is related to US Patent Application being filed on Jul. 1, 2005 based upon and claims the benefit of priority from the prior Japanese Patent Application No. 2004-196033, filed on Jul. 1, 2004, and to U.S. Patent Application being filed on Jul. 1, 2005 based upon and claims the benefit of priority from the prior Japanese Patent Applications No. 2004-196030, filed on Jul. 1, 2004, and No. 2004-196031, filed on Jul. 1, 2004. These applications including specifications, drawings, and claims are expressly incorporated herein by reference in their entirety.

### BACKGROUND OF THE INVENTION

1. Field of the Invention

The present invention relates to a game system in which multiple terminal devices and a server are connected via a communication line. More particularly, the present invention relates to a game system that can execute a multiplayer online game, such as MMORPG (Massively Multiplayer Online Role Playing Game), RTS (Real Time Strategy), FPS (First Person Shooting Game), or the like.

2. Description of Related Art

In recent years, with the development of information communication technologies, a game system in which multiple office or home terminal devices and a server are connected via a communication line is spreading. In the game system, various online games can be executed. Recently, as online games, for example, a multiplayer online game, such as MMORPG (Massively Multiplayer Online Role Playing Game), RTS (Real Time Strategy), FPS (First Person Shooting Game), or the like, is provided.

In terms of a player, such a multiplayer online game is attractive in that he can play a game with many and unspecified players who are not acquainted with him at remote places via a network, such as Internet, at home and abroad and communication can be performed by means of the game. Further, the multiplayer online game has been gaining support from all countries of the world. On the other hand, in terms of a game manufacturer, the multiplayer online game has advantages in that the semi-permanent game environment can be constructed by updating data or program regarding new events, characters, items, and the like sequentially and by distributing data or program to the respective terminal devices via the network. Accordingly, the game manufacture can ensure stable profits, without causing the players to lose interest in the game.

In the multiplayer online game, generally, the characters are set to correspond to the respective players, and each player operates a character of his own to participate in the game (see Japanese Patent Laid-Open No. 2002-224448). The corresponding character gains experience by clearing various conditions (so-called missions) and increases the level. With the increase of the level, the ability or position of the character is improved, such that the character can perform various functions. When the mission is cleared, money, which can be used on the game, is imparted to the player as the reward by the amount according to the difficulty of that mission. For this reason, the player can acquire a lot of money by clearing many missions and can buy weapons or items, which can be used on the game, so as to progress the game favorably.

Further, in the multiplayer online game, a so-called chat can be performed. In this case, if the message is transmitted from the terminal device operated by each player to the server, the message is transmitted from the server to the terminal devices operated by all players (See Japanese Patent Laid-Open Nos. 2004-89584 and 2003-181147) By performing the chat, the player can communicate with other players and can obtain all kinds of information regarding the game.

### SUMMARY OF THE INVENTION

During the chat described above, since the message is transmitted from the server to the terminal devices operated by all players, the message may be transmitted to some player whom the message would not be transmitted. Accordingly, the construction of close friendship and an exchanged of beneficial information with a specified player through the communication cannot be achieved.

Further, in the chat or the like, it is assumed that the players actually participate in the game simultaneously, and it is impossible or difficult to perform the communication among the players at different points of time.

It is an object of the invention to provide a game system in which an exchange of beneficial information with a specified player through the communication can be achieved.

It is another object of the invention to provide a game system that allows the communication among players to be achieved at different points of time.

According to a first aspect of the invention, there is provided a game system in which a plurality of terminal devices, each having a display unit, and a server are connected via a communication line and in which a plurality of players operates characters corresponding to the respective players by using the respective terminal devices to play a game, comprising: an image display control unit for causing the display unit to display a game image including the characters; a selection unit, according to an operation of a player, selecting any one of characters corresponding to other players than the player, who performs the operation, from among the characters included in the game image; a message input unit for inputting a message according to an operation of the player; and a message transmission unit for transmitting the message inputted by the message input unit to a terminal device used by a player who operates the character selected by the selection unit.

In accordance with the above-described configuration, a player can select a character included in a game image so as to specify a player serving as a destination and transmit a message to the specified player. Therefore, an exchange of beneficial information with the specified player through the communication can be achieved. Further, only by selecting the character included in the game image, the player serving as the destination of the message can be specified with superior operationality.

According to a second aspect of the invention, there is provided a game system in which a plurality of terminal devices, each having a display unit, and a server are connected via a communication line and in which a plurality of players operates characters corresponding to the respective players by using the respective terminal devices to play a game, comprising:

an image display control unit for causing the display unit to display a game image including the characters and for causing the display unit to display the game image such that a character corresponding to a player moves according to an operation of the player;

a message input unit provided in each of the terminal devices for inputting a message according to an operation of the player;

a first position determination unit for determining whether or not any one of the characters is at a first position;

an input permission unit for, when the first position determination unit determines that one character is at the first position, permitting the massage input unit of a terminal device used by a player, who operates the character, to input a message via the communication line; and a message storage unit provided in the server for storing the message inputted by the massage input unit, which is permitted to input the message by the input permission unit.

In accordance with the above-described configuration, the message is stored in the message storage unit, such that the communication at different points of time among the players can be achieved.

### BRIEF DESCRIPTION OF THE DRAWINGS

Other and further objects, features, and advantages of the invention will appear more fully from the following description taken in connection with the accompanying drawings in which:

FIG. 1 is a diagram showing a configuration of a game system according to a first embodiment of the invention;

FIG. 2 is a perspective view showing eight terminal devices and one card vending machine, which are disposed in a shop, in the game system of FIG. 1;

FIG. 3 is a perspective view showing one of the terminal devices of FIG. 2;

FIG. 4 is a block diagram showing a hardware configuration in the terminal device of FIG. 3;

FIG. 5 is a block diagram showing a hardware configuration of a shop server in the game system of FIG. 1;

FIG. 6 is a block diagram showing a hardware configuration of a center server in the game system of FIG. 1;

FIG. 7 is a block diagram showing a hardware configuration of the card vending machine shown in FIG. 2;

FIG. 8 is a flowchart showing a game play flow in the game system of FIG. 1;

FIG. 9 is a flowchart showing a processing which is executed by a card vending machine, a shop server, and a center server when an ID card is issued.

FIG. 10 is a diagram showing player participation information;

FIG. 11 is a diagram illustrating a data communication among respective shop servers;

FIG. 12 is a flowchart showing a processing which is executed by a terminal device, a shop server, and a center server until a game starts;

FIG. 13A is a diagram showing an example of player history data;

FIG. 13B is a diagram showing an example of game history data;

FIG. 14 is a diagram showing an example of player information;

FIG. 15 is a flowchart showing a game execution processing routine which is executed by a terminal device;

FIG. 16 is a flowchart showing a guild execution processing routine which is executed at a step S120 of FIG. 15;

FIG. 17A is a diagram schematically showing an image which is displayed on a first display of a terminal device when the routine of FIG. 16 is executed;

FIG. 17B is a diagram schematically showing an image which is displayed on a first display of a terminal device when the routine of FIG. 16 is executed;

FIG. 18 is a flowchart showing a mission reference/acceptance processing routine which is executed at a step S131 of FIG. 16;

FIG. 19 is a flowchart showing a processing which is executed by a shop server corresponding to the routine of FIG. 18 executed by a terminal device;

FIG. 20 is a diagram showing mission summary data;

FIG. 21A is a diagram schematically showing an image which is displayed on a first display of a terminal device when the routine of FIG. 18 is executed;

FIG. 21B is a diagram schematically showing an image which is displayed on a first display of a terminal device when the routine of FIG. 18 is executed;

FIG. 21C is a diagram schematically showing an image which is displayed on a first display of a terminal device when the routine of FIG. 18 is executed;

FIG. 21D is a diagram schematically showing an image which is displayed on a first display of a terminal device when the routine of FIG. 18 is executed;

FIG. 22 is a flowchart showing a board use processing which is executed at a step S133 of FIG. 16 and a processing which is executed by a shop server corresponding to the board use processing;

FIG. 23 is a diagram showing an example of a message list which is used when a step S1334 of FIG. 22 is performed;

FIG. 24A is a diagram schematically showing an image which is displayed on a first display of a terminal device when the processing of FIG. 22 is executed;

FIG. 24B is a diagram schematically showing an image which is displayed on a first display of a terminal device when the processing of FIG. 22 is executed;

FIG. 24C is a diagram schematically showing an image which is displayed on a first display of a terminal device when the processing of FIG. 22 is executed;

FIG. 25 is a flowchart showing a reward payment processing which is executed at a step S135 of FIG. 16 and a processing which is executed by a shop server corresponding to the reward payment processing;

FIG. 26 is a diagram showing an example of a reward decision table;

FIG. 27 is a flowchart showing a mission game execution processing routine which is executed at a step S121 of FIG. 15;

FIG. 28 is a flowchart showing a processing which is executed by a shop server corresponding to the routine of FIG. 27 executed by a terminal device;

FIG. 29 is a diagram showing an example of a chat message list;

FIG. 30A is a diagram schematically showing an image which is displayed on a first display of a terminal device when the processings of FIGS. 27 and 28 are executed;

FIG. 30B is a diagram schematically showing an image which is displayed on a first display of a terminal device when the processings of FIGS. 27 and 28 are executed; FIG. 30C is a diagram schematically showing an image which is displayed on a first display of a terminal device when the processings of FIGS. 27 and 28 are executed; FIG. 30D is a diagram schematically showing an image which is displayed on a first display of a terminal device when the processings of FIGS. 27 and 28 are executed;

FIG. 31 is a flowchart showing a biographical data generation processing which is executed by a center server;

FIG. 32 is a diagram showing an example of a history data evaluation table;

FIG. 33 is a diagram showing an example of an evaluation message creation table;

FIG. 34 is a flowchart showing a processing which is executed by a card vending machine and a center server when a biographical image is displayed;

FIG. 35 is a diagram schematically showing a biographical image which is displayed on a display of a card vending machine when the processing of FIG. 34 is executed;

FIG. 36 is a diagram showing a configuration of a game system according to the invention, as another example different from that of FIG. 1;

FIG. 37 is a diagram schematically showing an image which is displayed on a first display of a terminal device when the routine of FIG. 16 is executed, in a game system according to another embodiment of the invention;

FIG. 38 is a flowchart showing a reward payment processing which is executed at a step S135 of FIG. 16 and a processing which is executed by a shop server corresponding to the reward payment processing, as a modification different from that of FIG. 25;

FIG. 39A is a diagram showing a reward decision table, as another example different from that of FIG. 26;

FIG. 39B is a diagram showing a reward decision table, as another example different from that of FIG. 26;

FIG. 40 is a flowchart showing a processing which is executed by a card vending machine and a center server when a biographical image is displayed, as a modification different from that of FIG. 34;

FIG. 41 is a diagram schematically showing a biographical image which is displayed on a display of a card vending machine when the processing of FIG. 40 is executed;

FIG. 42 is a diagram showing a message list, as another example different from that of FIG. 23;

FIG. 43 is a flowchart showing an example of an input completion message transmission processing routine which is executed by a shop server at a step S3330 of FIG. 22; and

FIG. 44 is a diagram showing an example of an input completion message list.

### DESCRIPTION OF THE PREFERRED EMBODIMENTS

Hereinafter, preferred embodiments of the invention will be described with reference to the drawings.

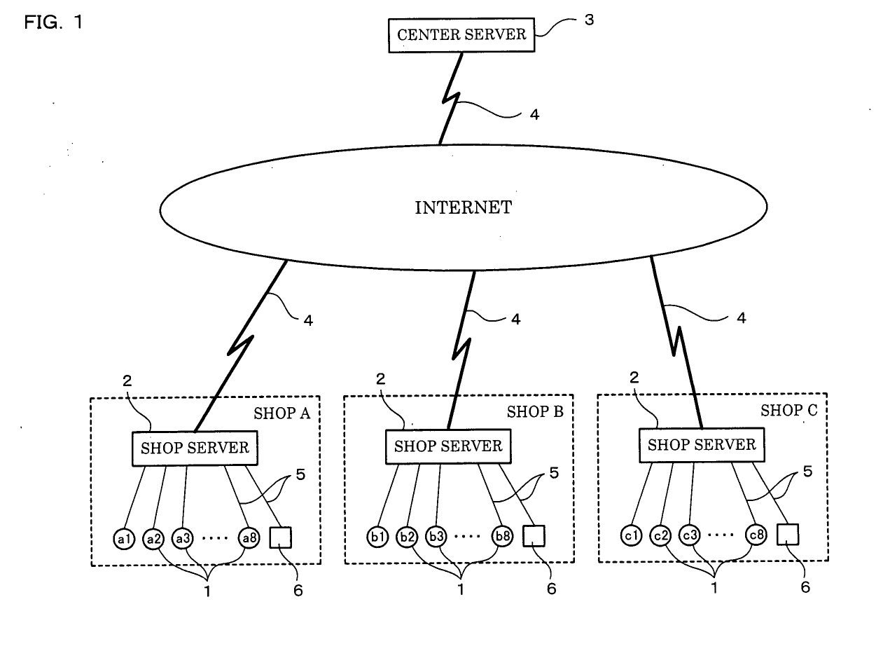

First, referring to FIG. 1, the configuration of a game system according to an embodiment of the invention will be described. The game system of the present embodiment includes three shop servers 2 that are disposed at three shops, respectively, eight terminal devices 1 and one card vending machine 6 that are communicatably connected to the shop server 2 via a private line 5 at each shop, and a center server 3 that manages a game which is played by a player with a terminal device 1. The three shop servers 2 can communicate with one another via a communication line 4.

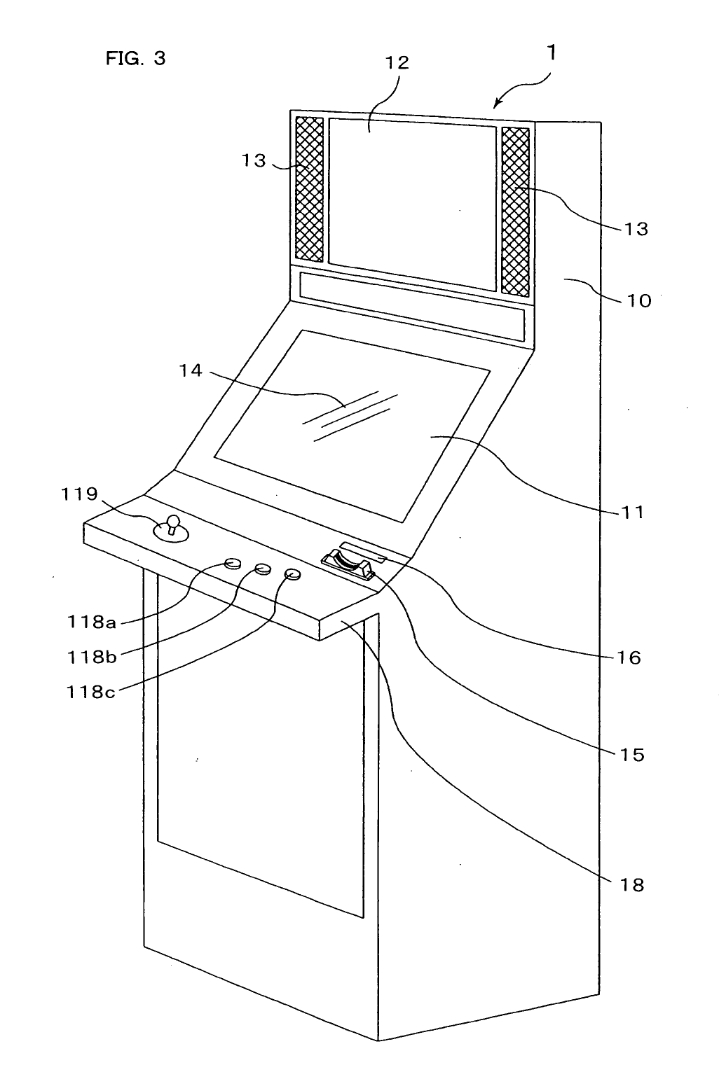

The terminal device 1 receives a predetermined operation which is performed by the player via a touch panel 14 (see FIG. 3) and progresses the game based on data transmitted from the shop server 2 (or the center server 3), data from other terminal devices 1, or the like.

Each terminal device 1 has unique machine ID. The machine ID includes a code of the shop server 2 to which the terminal device 1 is connected and a code of each terminal device 1 which is disposed in the shop. For example, when the code of the shop server 2 at the shop A is A and when the code of the terminal device 1 in the shop A is 1, the machine ID of the terminal device 1 is a1.

The shop server 2 performs a data communication between the terminal devices 1 and the center server 3. The center server 3 is communicatably connected to the respective shop servers 2 via the communication line 4 and stores history data regarding the respective players. The center server 3 performs the data communication with the terminal devices 1 via the shop server 2 and performs a processing, such as an authentication of each player, or the like. The shop server 2 corresponds to a server according to the invention.

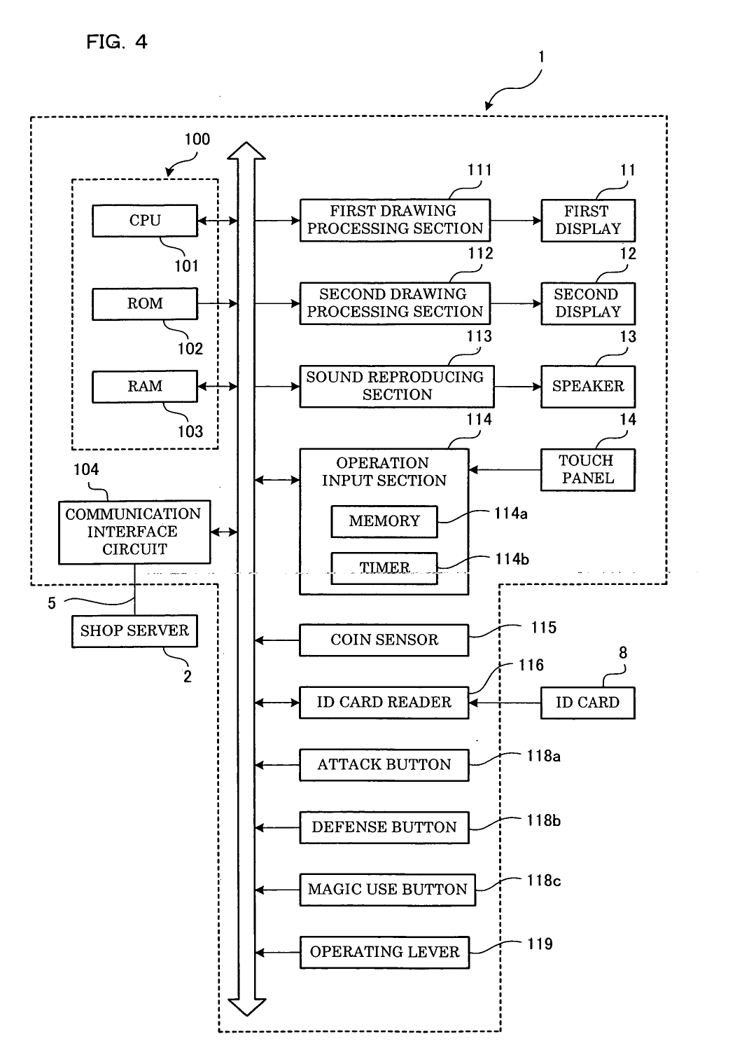

The card vending machine 6 is communicatably connected to the center server 3 via the shop server 2 so as to receive an input operation of individual data by a player and to issue an ID card 8 (see FIG. 4). The player is registered in the center server 3 according to individual data inputted at that time and then is imparted with identifiable ID data through the center server 3. In the issued ID card 8, ID data is imparted in advance. When the ID data is imparted, a password inputted by the player is stored in a RAM 303 and is used for the authentication of the player at the time of the game start.

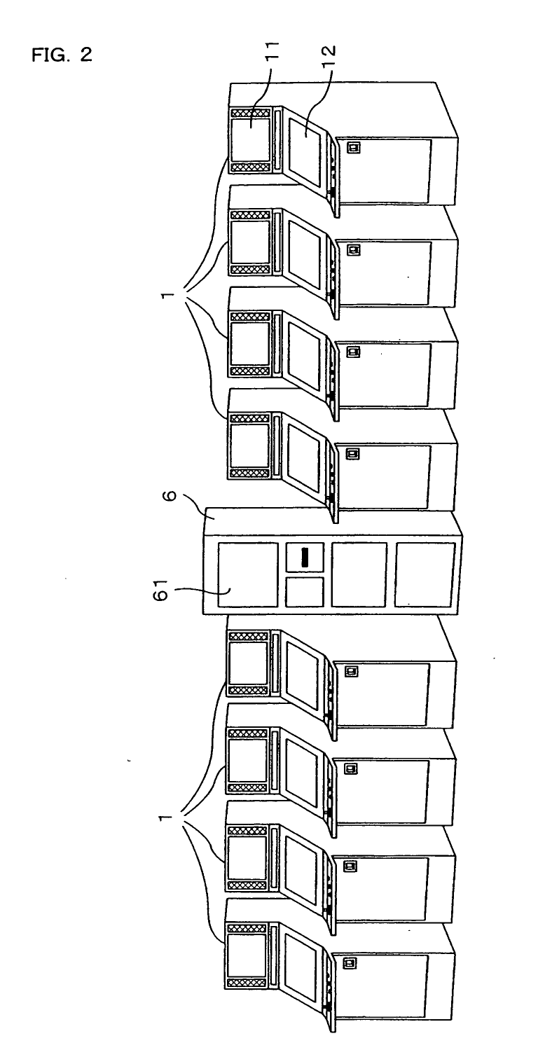

FIG. 2 is a perspective view showing appearances of eight terminal devices and one card vending machine which are disposed at one shop. FIG. 3 is a perspective view showing one of the terminal devices of FIG. 2.

The game executed by using the terminal device 1 is the MMORPG (Massively Multiplayer Online Role Playing Game) which introduces elements of an action game. The player who operates the terminal device 1 operates a corresponding character by using various buttons 118 and an operating lever 119 so as to progress the game. The respective characters belong to an adventurer guild (which means a fellow group on the game constructed by adventurers and, hereinafter, which is simply referred to as a guild) and accept a mission (which means a condition on the game set for each player) from the guild. After accepting the mission from the guild, the character performs a mission game to adventure a virtual game space. In the mission game, it is possible to strength the character by fighting with a monster and increasing the level and to gain an item. Since the characters corresponding to the respective players perform the game in the same virtual game space, a player can challenge the mission together with the character corresponding to any other player or can exchange information with the character corresponding to any other player. When clearing the mission in the virtual game space and then returning to the guild, the player can receive a reward according to the kind of the mission from the guild and accept a new mission.

As shown in FIG. 3, the terminal device 1 has a cabinet 10, a first display 11 that is provided to be inclined at a predetermined angle on the front surface of the cabinet 10, and a second display 12 that is provided above the first display 11. On the first display 11, a game image representing the virtual game space in which the character is disposed, an image representing the guild, and the like are displayed. On the second display 12, various images, such as an image representing a map (a general view) of the virtual game space, an image for advertisement of the game, and the like, are displayed. The first display 11 corresponds to a display unit according to the invention.

On the first display 11, the touch panel 14 is provided. The touch panel 14 can detect a contact by the player and, when detecting the contact, output a detection signal representing a contact position to an operation input section 114 (see FIG. 4) which will be described below. The player contacts the touch panel 14 so as to input various instructions. On both sides of the second display 12, speakers 13 that output sound are provided.

Below the first display 11, a coin insertion slot 15 into which a coin is inserted and an ID card insertion slot 16 into which the ID card is inserted are provided. The coin inserted into the coin insertion slot 15 is detected by a coin sensor 115 (see FIG. 4). From the ID card inserted into the ID card insertion slot 16, ID data is read out by an ID card reader 116 (see FIG. 4).

On the cabinet 10, a base portion 18 is provided so as to project forward. On the upper surface of the base portion 18, an attack button 118a, a defense button 118b, a magic use button 118c, and the operating lever 119 are provided. The attack button 118a is a button for inputting an instruction to cause the character to perform an attack operation. The defense button 118b is a button for inputting an instruction to cause the character to perform a defense operation. The magic use button 118c is a button for inputting an instruction to cause the character to perform a magic use operation. The operating lever 119 is one for inputting an instruction to move the character.

FIG. 4 is a block diagram showing a hardware configuration of a terminal device. A control section 100 controls the overall operation of the terminal device 1 and includes a CPU 101, a ROM 102, and a RAM 103.

The ROM 102 stores various image data, programs, and the like. Specifically, the ROM 102 stores, for example, image data representing images to be displayed on the first display 11 and/or the second display 12, such as various character images that represent a character operated by a player, characters operated by other players, and the like, monster images that represents monsters appearing in the virtual game space, various background images that represent the virtual game space, an image representing the guild, and the like. In addition, the ROM 102 stores, for example, objects constituting the characters or the monsters, texture data, background images, and the like. The objects constituting the characters or the monsters and the like are constructed by the predetermined number of polygons for three-dimensional drawing. The ROM 102 stores an ability setting table (not shown) in which the levels of the players or the characters corresponding to the players and the abilities of the characters are correlated with each other.

The ROM 102 may be a storage medium built in the terminal device 1 or may be a detachable storage medium. Further, the ROM 102 maybe constructed by using both storage mediums. Among various data stored in the ROM 102, data which can be stored in the detachable storage medium may be read out by a driver, such as a hard disk drive, an optical disk drive, a flexible disk drive, a silicon disk drive, or a cassette medium reader. In this case, the storage medium may be, for example, a hard disk, an optical disk, a flexible disk, a CD, a DVD, or a semiconductor memory.

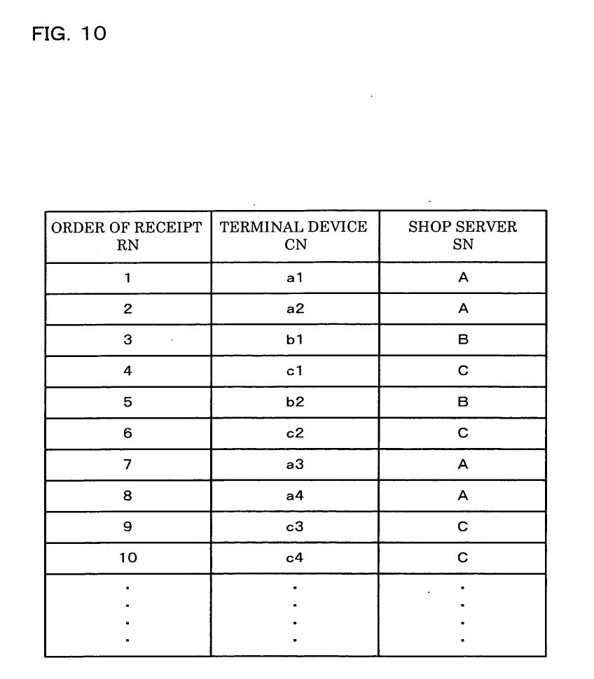

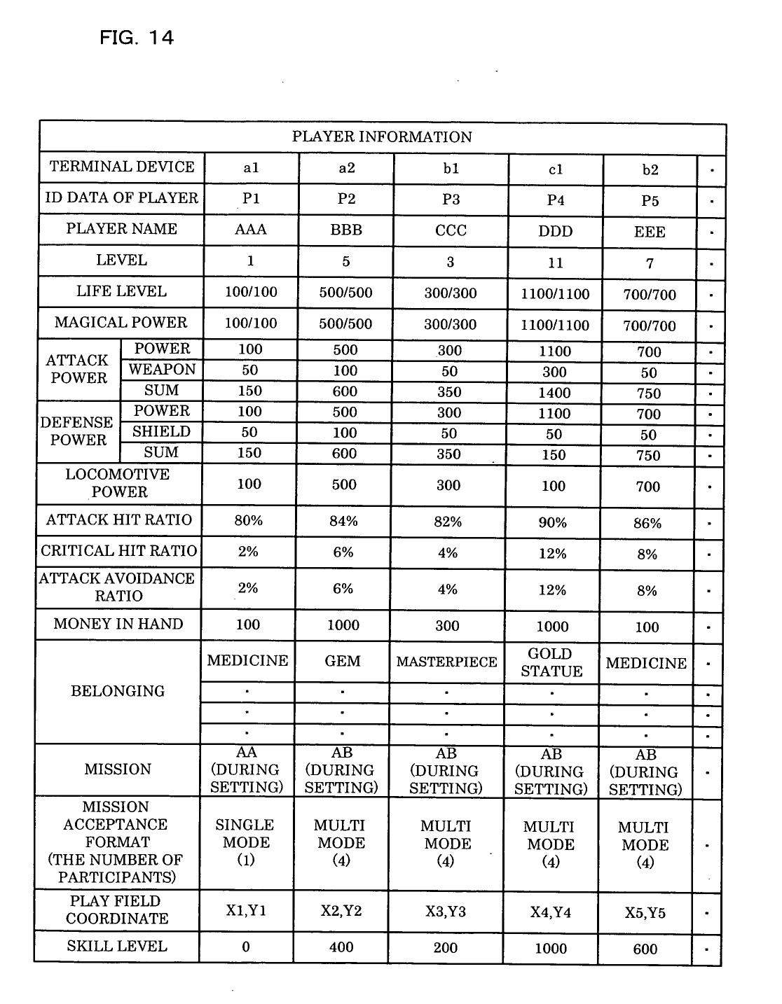

The RAM 103 temporarily stores information, variables, and the like during processing. The RAM 103 stores, for example, player participation information (see FIG. 10), player information (see FIG. 14), or the like. The CPU 101 selects a single mode in which a single player participates in any mission on the game or a multi mode in which the player participates in the mission together with other players, according to the input operation of the player with the touch panel 14, and stores the selection result in the player information.

A communication interface circuit 104 communicates data (for example, the player participation information, the player information, or the like) with the shop server 2 via the private line 5. The communication interface circuit 104 transmits the instruction inputted by the player through the touch panel 14, various buttons 118, or the operating lever 119 to the shop server 2 via the private line 5 and then the shop server 2 progresses the game based on the instruction. Further, the communication interface circuit 104 receives a display command for the first display 11 or the second display 12 from the shop server 2 via the private line 5. Based on the display command, various images are displayed on the first display 11 and the second display 12.

A first drawing processing section 111 causes the first display 11 to display the game image in which the characters are disposed in the virtual game space, the image representing the guild, or the like. The first drawing processing section 111 includes a VDP (Video Data Processor), a video RAM, or the like. According to the display command, the first drawing processing section 111 refers to the player information (see FIG. 14) stored in the RAM 103 and extracts image data from the ROM 102. Then, the first drawing processing section 111 stores image data in the video RAM according to a display priority on the first display 11 (for example, in an order of the background images, the monster images, and the character images), generates the game image, and outputs the generated game image to the first display 11. As a result, the game image is displayed on the first display 11. Further, when the game image is expressed in a three-dimensional image, first, the first drawing processing section 111 performs a calculation for converting positions of the objects (for example, the objects constituting the characters, the monsters, or the like) stored in the ROM 102 on the three-dimensional space into positions of them on a pseudo three-dimensional space, an optical source calculation processing, or the like. Then, the first drawing processing section 111 performs a write processing of image data to be drawn on the video RAM based on the calculation result (for example, mapping of texture data to the areas of the video RAM designated by the polygons, or the like). Accordingly, the game image is generated and is outputted to the first display 11. As a result, on the first display 11, the game image constituted by three-dimensional images is displayed. In the game system according to the present embodiment, the characters corresponding to multiple players play the game in the same virtual game space. Here, when the characters exist to be close to each other in the virtual game space, the first drawing processing section 111 displays on the first display 11 the game image which includes multiple character images representing the respective characters. The first drawing processing section 111 functions as an image display control unit that displays the game image including the character images representing the respective characters on the first display 11.

A second drawing processing section 112 causes the second display 12 to display the image representing the map of the virtual game space, the image representing the advertisement of the game, or the like and includes a VDP (Video Data Processor), a video RAM, or the like. The second drawing processing section 112 extracts a predetermined image from the ROM 102 according to the display command. Then, the second drawing processing section 112 stores image data in the video RAM according to a display priority on the second display 12. Accordingly, the predetermined image is generated and is outputted to the second display 12. As a result, the predetermined image is displayed on the second display 12.

A sound reproducing section 113 outputs predetermined sound, BGM, or the like to the speakers 13 according to an instruction from the shop server 2. The touch panel 14 is a thin layer structure which is provided in front of the first display 11. The touch panel 14 is constructed by arranging linear pressure-sensitive members made of a transparent material at predetermined pitches in horizontal and vertical directions and by coating a transparent cover thereon. As the touch panel 14, the well-known touch panels in the related art maybe adopted. The touch panel 14 outputs the detection signal indicating the contact position when contacting to the operation input section 114.

The operation input section 114 is a microcomputer having a memory 114a and a timer 114b. The contact position indicated by the detection signal outputted from the touch panel 14 is buffered in a predetermined area of the memory 114a as data. Subsequently, the instruction content is determined based on the data by using the timer 114b or the like and the determination result is supplied to the control section 100 as an operation command.

The coin sensor 115 transmits a predetermined signal to the control section 100 when detecting the coin inserted into the coin insertion slot 15. The ID card reader 116 reads out ID data from the ID card 8 inserted into the ID card insertion slot 16 and supplies read ID data to the control section 100. The attack button 118a is a button for causing the character to perform the attack operation. The defense button 118b is a button for causing the character to perform the defense operation. The magic use button 118c is a button for causing the character to perform the magic use operation. When detecting the operations by the player, the buttons 118a to 118c transmits detection signals to the control section 100. When being inclined in a predetermined direction by the player, the operating lever 119 transmits a detection signal according to that direction to the control section 100.

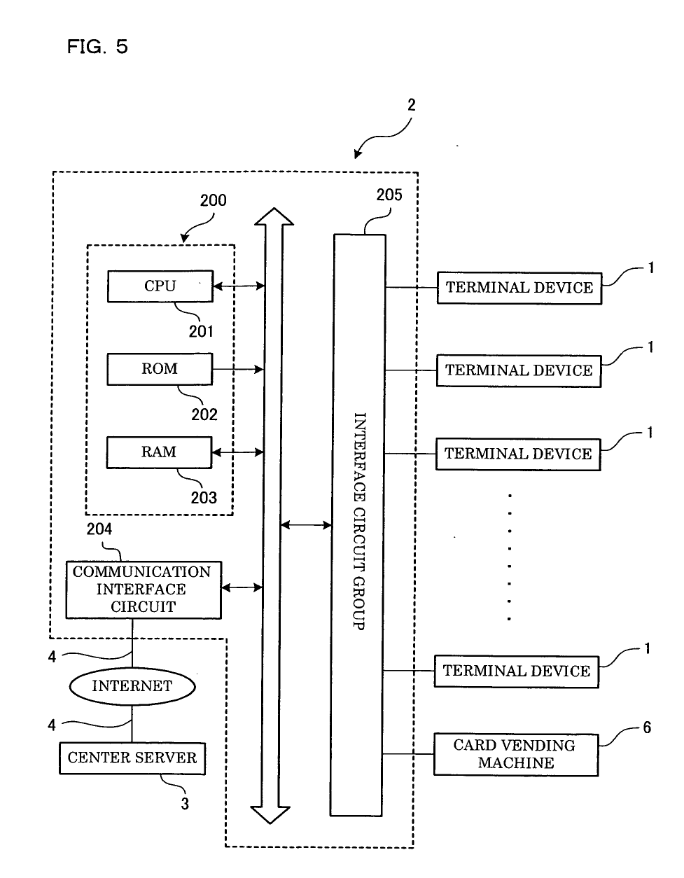

As shown in FIG. 5, the shop server 2 has a control section 200 that controls the overall operation of the shop server 2. The control section 200 includes a CPU 201, a ROM 202, and a RAM 203.

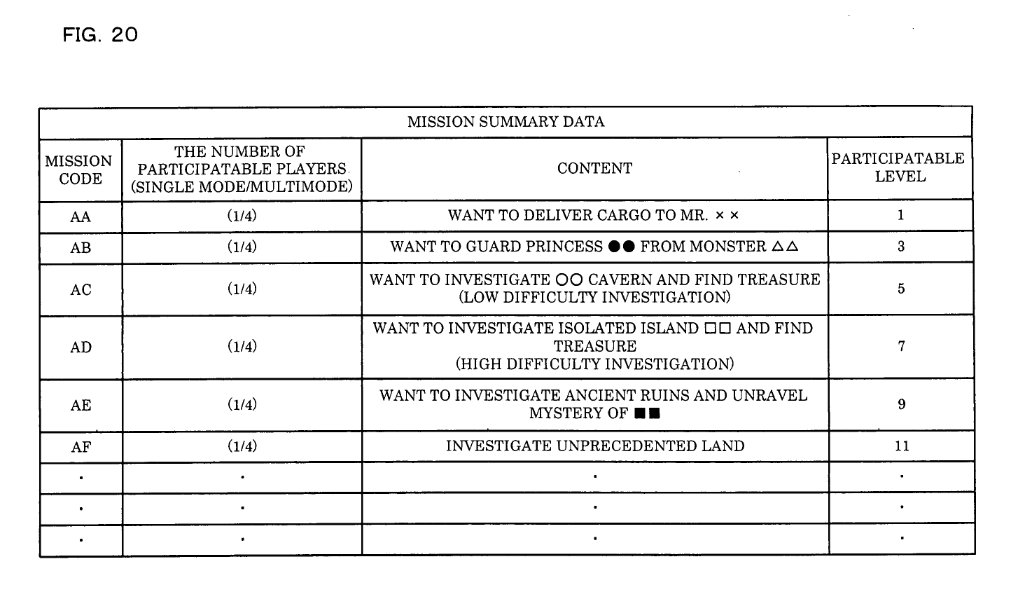

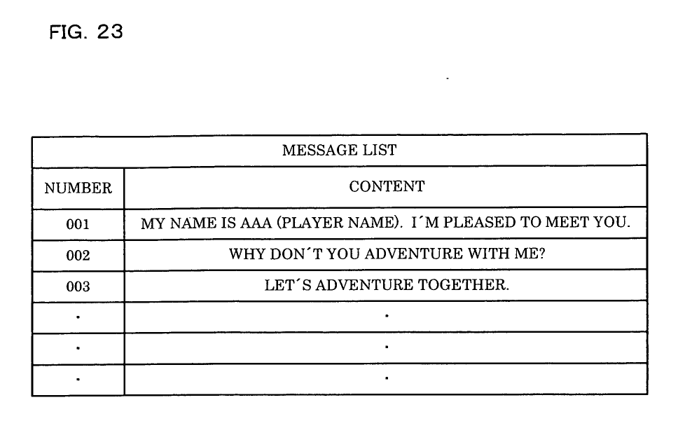

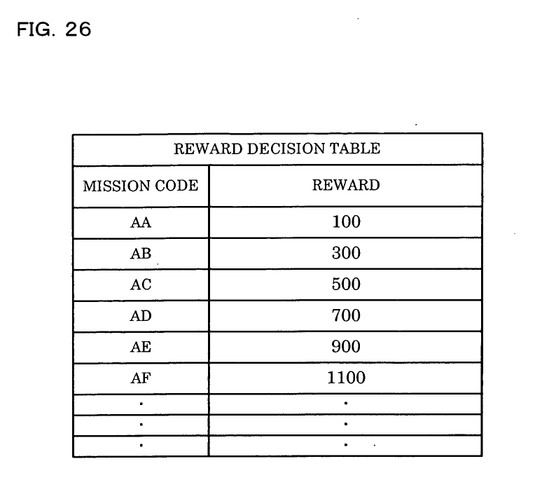

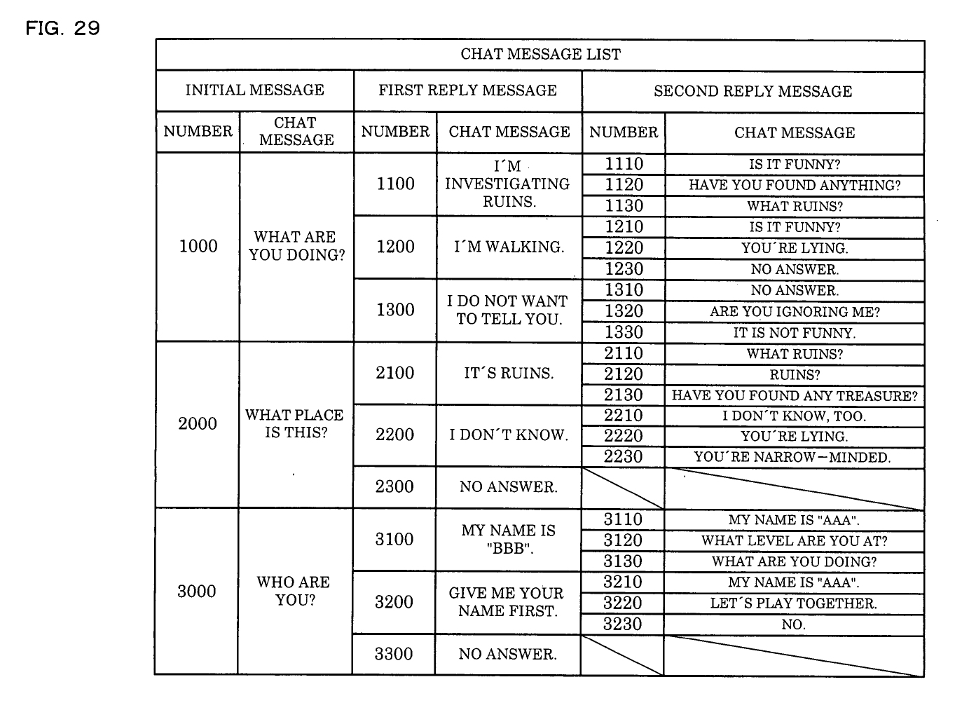

The ROM 202 stores a game control program. The CPU 201 of the shop server 2 executes the game control program stored in the ROM 202 and performs various processings so as to progress the game. Further, the ROM 202 stores various data or table data to be used to progress the game, such as, mission summary data representing a summary of a mission set for a player in the game system of the present embodiment (see FIG. 20), mission reference data representing detail contents of the respective missions, a message list in which messages to be inputted by the player on the guild board are stored (see FIG. 23), a reward decision table for deciding the reward for the mission clear (see FIG. 26), a chat message list that is used for a message exchange (so-called chat) with other players in the mission game (see FIG. 29), and the like.

The ROM 202 may be a storage medium built in the shot server 2 or may be a detachable storage medium. Further, the ROM 202 maybe constructed by using both storage mediums. Among various data stored in the ROM 202, data which can be stored in the detachable storage medium may be read out by a driver, such as a hard disk drive, an optical disk drive, a flexible disk drive, a silicon disk drive, or a cassette medium reader. In this case, the storage medium may be, for example, a hard disk, an optical disk, a flexible disk, a CD, a DVD, or a semiconductor memory.

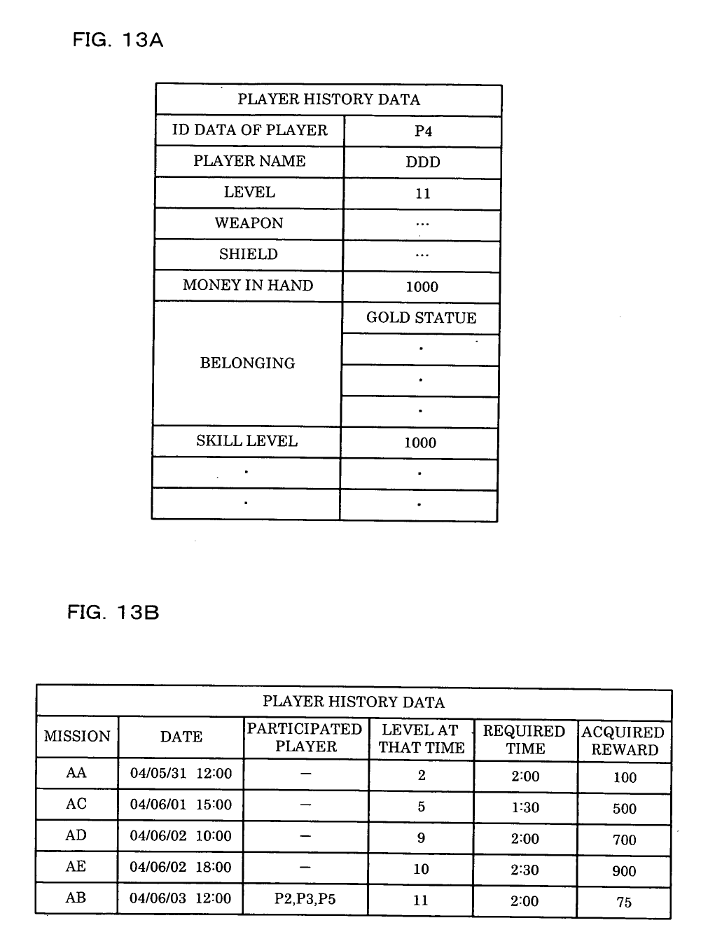

The RAM 203 temporarily stores information, variables, and the like during processing. The RAM 203 stores, for example, the player participation information (see FIG. 10), the player information (see FIG. 14), or the like. When player history data (see FIGS. 13A and 13B) is supplied from the center server 3, the RAM 203 stores this player history data.

A communication interface circuit 204 communicates various data with the center server 3 and other shop servers 2 via a network, such as Internet or the like. The shop server 2 has an interface circuit group 205 and the interface circuit group 205 is connected to eight terminal devices 1 and one card vending machine 6 via the private line 5.

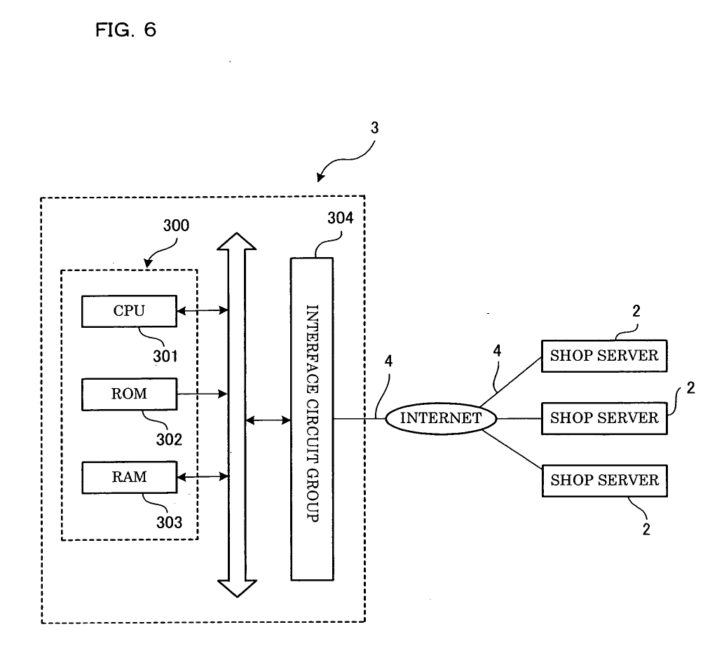

As shown in FIG. 6, the center server 3 has a control section 300 that controls the overall operation of the center server 3. The control section 300 includes a CPU 301, a ROM 302, and a RAM 303.

The ROM 302 may be a storage medium built in the center server 3 or may be a detachable storage medium. Further, the ROM 302 maybe constructed by using both storage mediums. Among various data stored in the ROM 302, data which can be stored in the detachable storage medium may be read out by a driver, such as a hard disk drive, an optical disk drive, a flexible disk drive, a silicon disk drive, or a cassette medium reader. In this case, the storage medium may be, for example, a hard disk, an optical disk, a flexible disk, a CD, a DVD, or a semiconductor memory.

The RAM 303 stores, for example, ID data, history data (see FIGS. 13A and 13B), and the password of each player. A communication interface circuit 304 communicates data with the respective shop servers 2 via the network, such as Internet or the like.

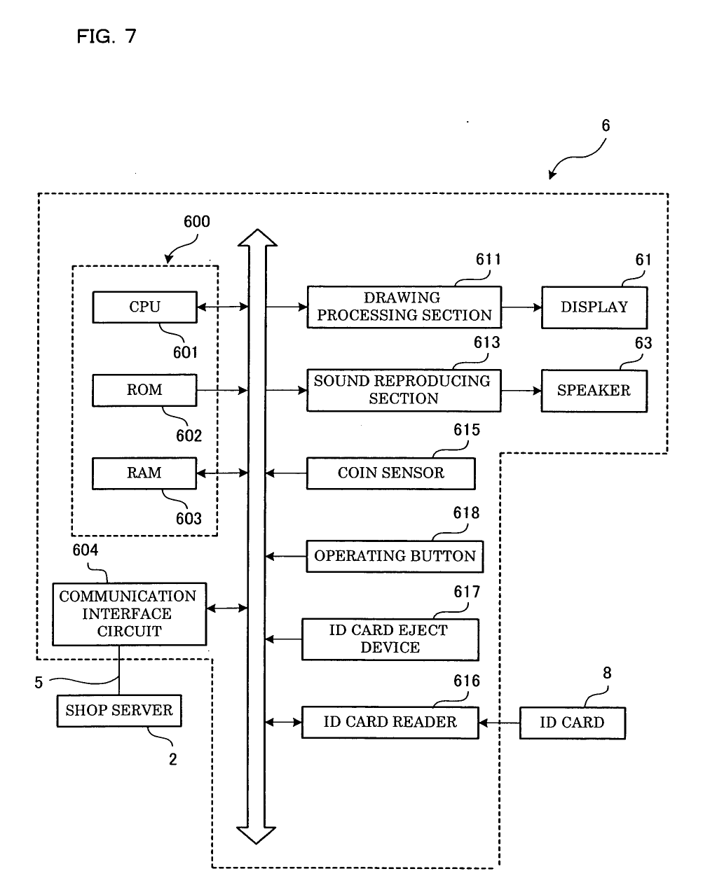

FIG. 7 is a block diagram showing the hardware configuration of the card vending machine 6. A control section 600 controls the overall operation of the card vending machine 6 and includes a CPU 601, a ROM 602, and a RAM 603.

The ROM 602 stores various image data and programs, such as image data constituting the biographical image, image data constituting the image representing the instruction to buy the ID card, or the like.

The ROM 602 may be a storage medium built in the card vending machine 6 or may be a detachable storage medium. Further, the ROM 602 may be constructed by using both storage mediums. Among various data stored in the ROM 602, data which can be stored in the detachable storage medium may be read out by a driver, such as a hard disk drive, an optical disk drive, a flexible disk drive, a silicon disk drive, or a cassette medium reader. In this case, the storage medium may be, for example, a hard disk, an optical disk, a flexible disk, a CD, a DVD, or a semiconductor memory.

The RAM 603 temporarily stores information, variables, and the like during processing. The RAM 603 stores, for example, history data (see FIGS. 13A and 13B), evaluation messages, biographical data, or the like. The CPU 601 generates multiple evaluation messages based on an instruction inputted via an operating button 618 or ID data read out by an ID card reader 616, which will be described below, and history data stored in the ROM 602, edits the multiple evaluation messages according to the time axis of the game, and generates biographical data representing the game progress state of the player. When the CPU 601 transmits a request signal purporting to request biographical data corresponding to ID data to the center server 3, biographical data received from the center server 3 is stored in the RAM 603. A communication interface circuit 604 communicates data (for example, history data, or the like) with the shop server 2 via the private line 5. A drawing processing section 611 causes a display 61 to display the biographical image and includes a VDP (Video Data Processor), a video RAM, or the like. Based on biographical data stored in the RAM 603, the drawing processing section 611 extracts various image data constituting the biographical image from the ROM 602 and stores image data in the video RAM according to a display priority on the display 61. Accordingly, the biographical image is generated and is outputted to the display 61. As a result, the biographical image is displayed on the display 61.

A sound reproducing section 613 outputs predetermined sound, BGM, or the like to a speaker 63. A coin sensor 615 transmits a predetermined signal to the control section 600 when detecting the coin inserted into the card vending machine 6. The operating button 618 has multiple buttons and is used to input various instructions to the card vending machine 6. The operating button 618 transmits a detection signal to the control section 600 when detecting the operation of the player. An ID card eject device 617 ejects one ID card among multiple ID cards stored in a predetermined place of the card vending machine 6 when the predetermined amount of the coin and individual data are inputted to the card vending machine 6. An ID card reader 616 reads out ID data from the ID card 8 inserted into the card vending machine 6.

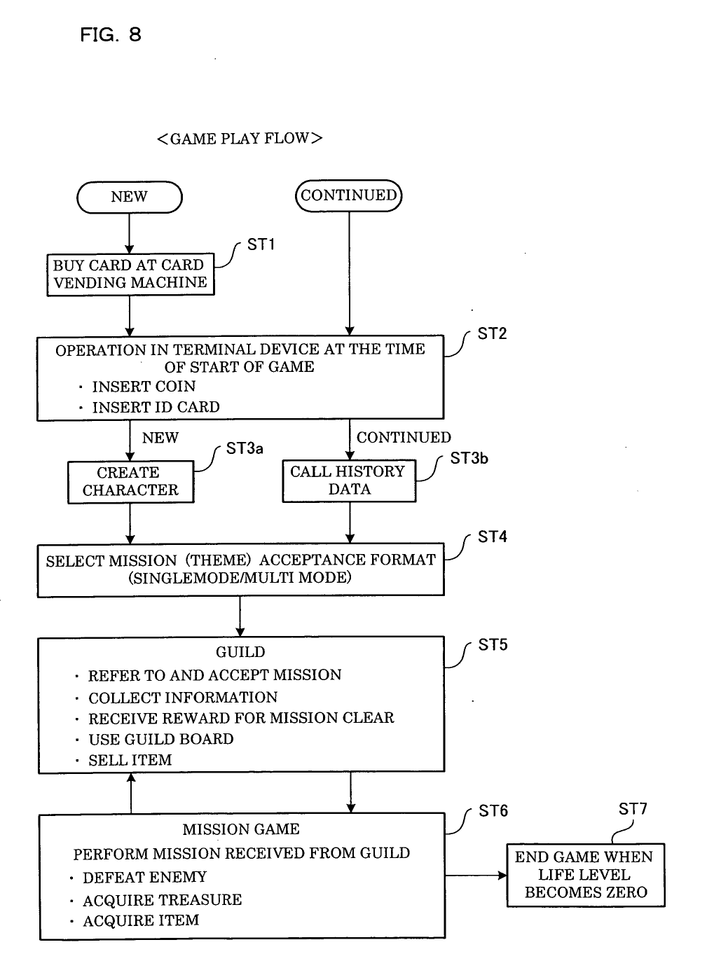

Next, a game play flow in the game system of the present embodiment will be described with reference to FIG. 8. A player, who plays the game newly, buys the ID card 8 at the card vending machine 6, first (ST1). Specifically, the player inserts the predetermined amount of the coin into the card vending machine 6 and inputs individual data of his own (for example, full name or first name, date of birth, blood type, asterism, or the like) by using the operating button 618. Then, the ID card 8 is ejected from the ID card eject device 617. Since a player, who plays the game continuously, obtains the ID card 8 in advance, the step of ST1 does not need to be performed.

The player, who plays the game newly or plays the game continuously, performs an operation through the terminal device 1 at the time of the game start (ST2). As the operation at the time of the game start, for example, the insertion of the coin into the coin inserting slot 15, the insertion of the ID card 8 into the ID card insertion slot 16, and the like may be exemplified.

After the step of ST2 is performed, when playing the game newly, the player creates the character (ST3a). Specifically, the player inputs an instruction trough the touch panel 14 so as to select the figure, ability, characteristic, and the like of the corresponding character (the character operated by the player) and create the character according to his liking. On the other hand, when the player plays the game continuously, history data (see FIGS. 13A and 13B) is stored in the RAM 303 of the center server 3. Then, history data is called from the center server 3, and, at the time of the game end, the figure, ability, characteristic, and the like of the character are set (ST3b).

After the step of ST3 (ST3a or ST3b) is completed, next, a mission acceptance format is selected (ST4). As described above, the mission is accepted from the guild, and the player can select any one of the single mode in which the player accepts the mission by himself and the multi mode in which the player accepts the mission together with other players. Further, the reward acquired when the mission is cleared is proportionally divided by the number of players who clear that mission. Therefore, when the single mode is selected, since the player has to clear the mission by himself, the difficulty of the mission is increased, but much reward can be acquired. On the other hand, when the multi mode is selected, since the player may clear the mission together with other players, the difficulty of the mission is lowered, but the reward to be acquired is decreased.

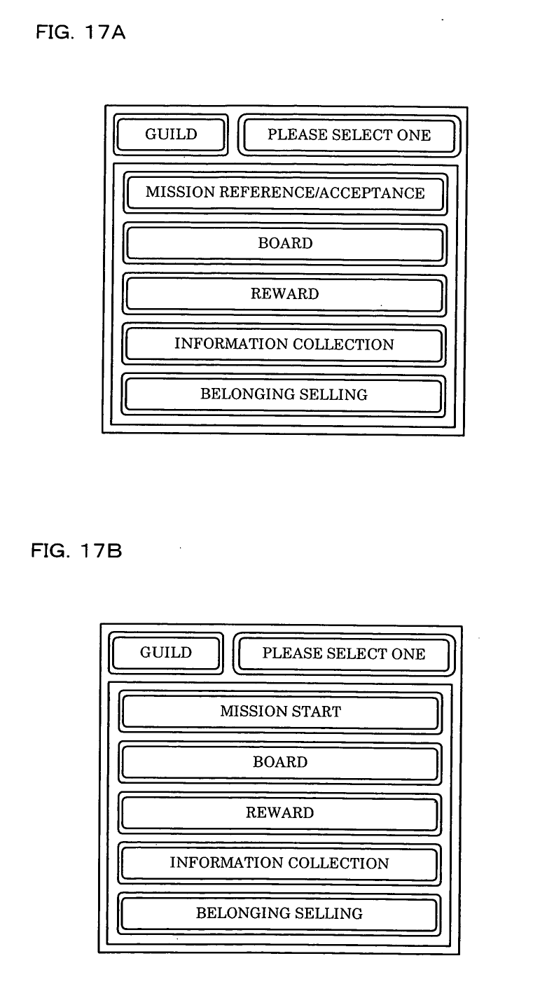

If the step of ST4 is completed, the game starts and the character corresponding to the player can appear on the guild and take various actions on the guild (ST5). In the guild, the player can perform, for example, the following (i) to (v) (see FIGS. 17A and 17B)

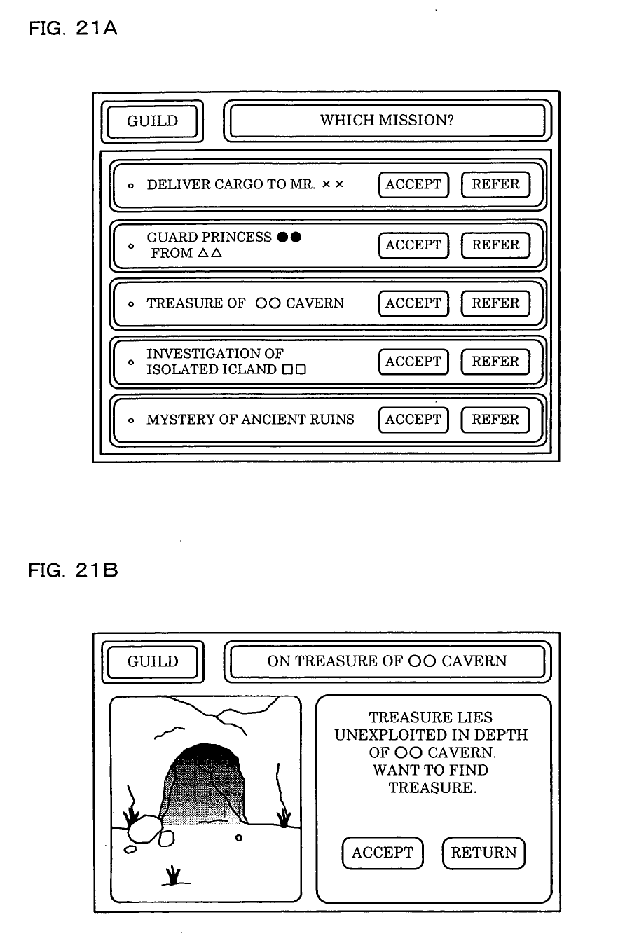

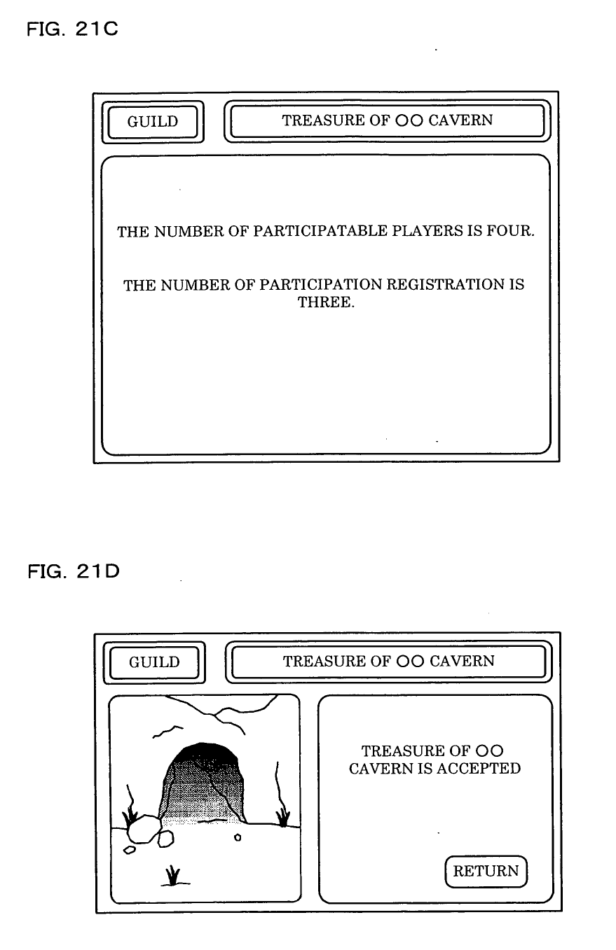

(i) Refer to or accept a mission (Only prior to the mission acceptance). In the present embodiment, for example, there are multiple missions, such as a mission of a serious content, a mission of a comical content, and the like (see FIGS. 20 and 21A). The player selects an interesting mission among the multiple missions so as to refer to the content of that mission (see FIG. 21B). After referring to the mission and grasping the mission, the player accepts the mission.

(ii) Collect information regarding other characters or missions. In the guild, the player can obtain information regarding other characters or missions. In particular, the player can obtain a hint for capturing the mission, information of the monsters appearing in the virtual game space, and information of an acquirable item by paying a predetermined amount of money which can be used on the game. As the information of other players, information about which character exists in the virtual game space and which adventure that character makes can be obtained. Moreover, the information that can be obtained in the (ii) step is information predetermined in the program, not information that can be obtained from other players.

(iii) Gain the reward for the mission clear (only when the mission is cleared). Here, the value of experience or money that can be used on the game is paid from the guild according to the level of the player (the character corresponding to the player) who cleared the mission. However, when the mission is cleared in the multi mode, the reward is proportionally divided by the number of players who cleared the mission.

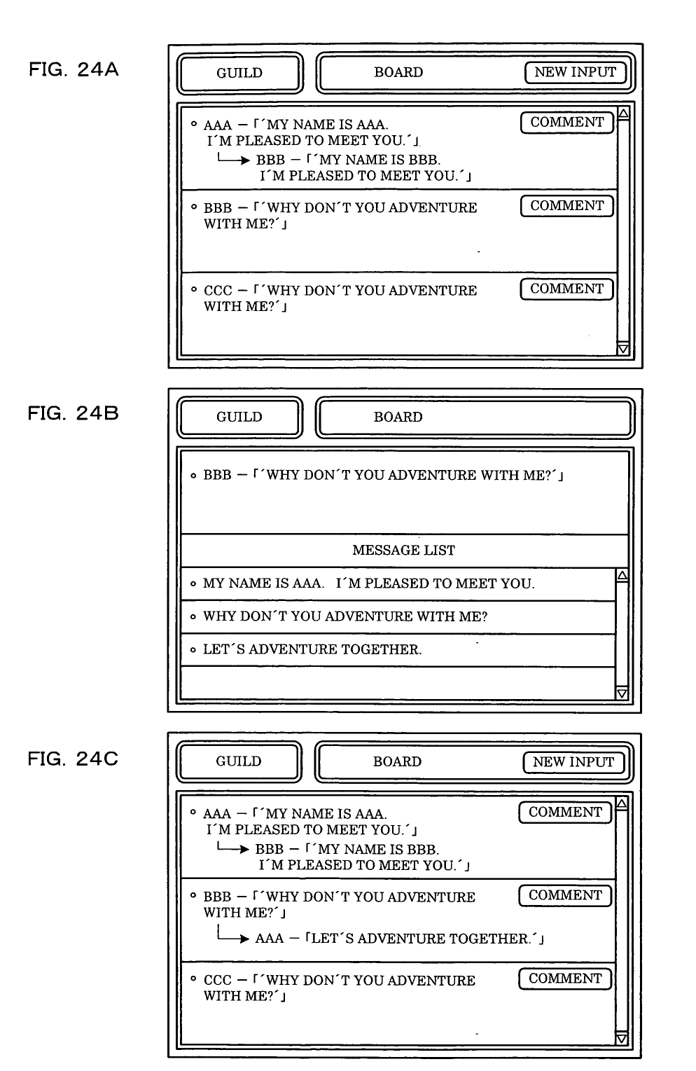

(iv) Use the board. Each player can write the message into the guild board. In this case, the message written by the player is displayed on the first display 11 of the terminal device 1 (FIGS. 24A to 24D). The board can be used for the players to exchange the information with each other. The player writes the message to other players so as to exchange the information regarding the mission with other players and invite other players to participate in the mission.

(v) Sell the belonging (the item possessed by the character). The character can sell the item obtained in the virtual game system or the item obtained as the reward for the mission clear on the guild.

(vi) Start the mission and progresses to the mission game (only after the mission acceptance). When the mission is accepted in the (i) step, the (vi) step is performed so as to progress to the mission game.

In the step of ST5 described above, the player contacts the image displayed on the first display 11 through the touch panel 14 so as to input various instructions.

In ST5, when the above-described (vi) step is performed, the mission game is progressed (ST6). The mission game is a game for achieving the mission received from the guild, which is at the core of the game in the present embodiment. In the mission game of ST6, the player uses various buttons 118 and the operating lever 119 to operate the corresponding character and make an adventure in the virtual game space. During the mission game, the life level of the character becomes zero (0) due to the attack from the monster or the like, the game ends (ST7).

In the mission game, when the character images representing other characters are displayed on the first display 11, a chat button is also displayed on the first display 11. At this time, if the player contacts the chat button via the touch panel 14, a chat window is opened on which various kinds of chat messages are displayed. The player contacts any one chat message of various kinds of the chat messages via the touch panel 14 so as to input the chat message. In addition, the player contacts the character image representing a character, which serves as a destination of the input chat message, via the touch panel 14, such that the chat message can be transmitted to the terminal device 1 of the player, who operates the character serving as the destination, via the shop server 2.

In ST6, when the mission is cleared, the player returns to the guild of ST5, receives the reward for the mission clear, and accepts a new mission to progress the mission game again. As such, in the present embodiment, the game is a game that is progressed by performing the guild (ST5) and the mission game (ST6) alternately.

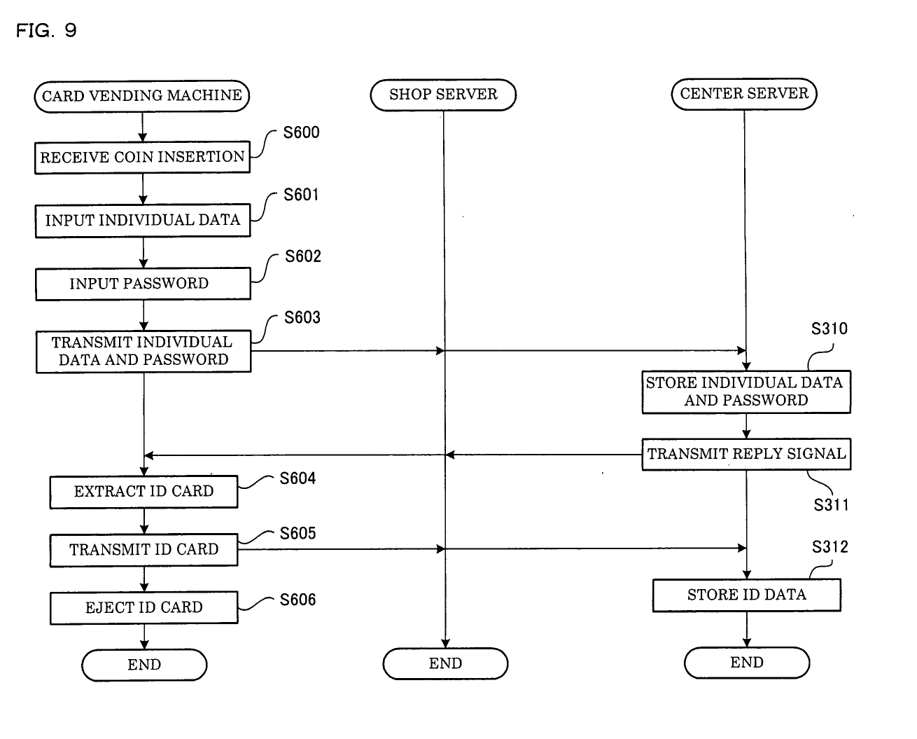

Next, the processing which is performed in the game system of the present embodiment when the game is progressed as described above will be described with reference to FIG. 9.

First, the CPU 601 of the card vending machine 6 receives the insertion of the coin into the card vending machine 6 (Step S600). When receiving the predetermined signal from the coin sensor 615 at the time of the coin detection, the CPU 601 receives the input of individual data (for example, full name or first name, date of birth, blood type, asterism, or the like) by the operation of the player (Step S601). In addition, the CPU 601 receives the input of the password by the operation of the player (Step S602). This password is used for the authentication of the player by the center server 3. Next, the CPU 601 transmits the input individual data and password to the center server 3 via the private line 5 by the communication interface circuit 604, while passing through the shop server 2 (Step S603).

The CPU 301 of the center server 3 stores the individual data and password transmitted from the terminal device 1 in the RAM 303 (Step S310). As such, the player is registered in the center server 3 and then the CPU 301 transmits a reply signal to the terminal device 1 (Step S311).

The CPU 601 of the card vending machine 6 extracts one ID card 8 among the multiple ID cards stored in the card vending machine 6 (Step S604). Then, ID data stored in the extracted ID card 8 is transmitted to the center server 3 (Step S605) and the ID card 8 is ejected. As a result, the player can obtain the ID card 8. On the other hand, the center server 3 that receives ID data stores ID data in correlating with the individual data and password stored in the RAM 303 (Step S312).

In the game system of the present embodiment, the game is progressed through the data communication between the respective terminal devices 1 and the shop server 2 that is connected to the terminal devices 1 via the private line 5. The player participation information that is stored in the RAM 203 of the shop server 2 connected to the terminal devices 1 via the private line 5 and the RAM 303 of the center server 3 at this time will be described with reference to FIG. 10.

In a table shown in FIG. 10, information of an order of receipt (RN) which is an order of participation in the game received by the center server 3, the machine ID (CN) which is identification information of the terminal device 1, and a shop server symbol (SN) which is identification information of the shop server 2 are stored sequentially from the left. In the game of the present embodiment, when the predetermined number (for example, 20) of players participates in the same game, a player participation status is managed by the player participation information shown in FIG. 10.

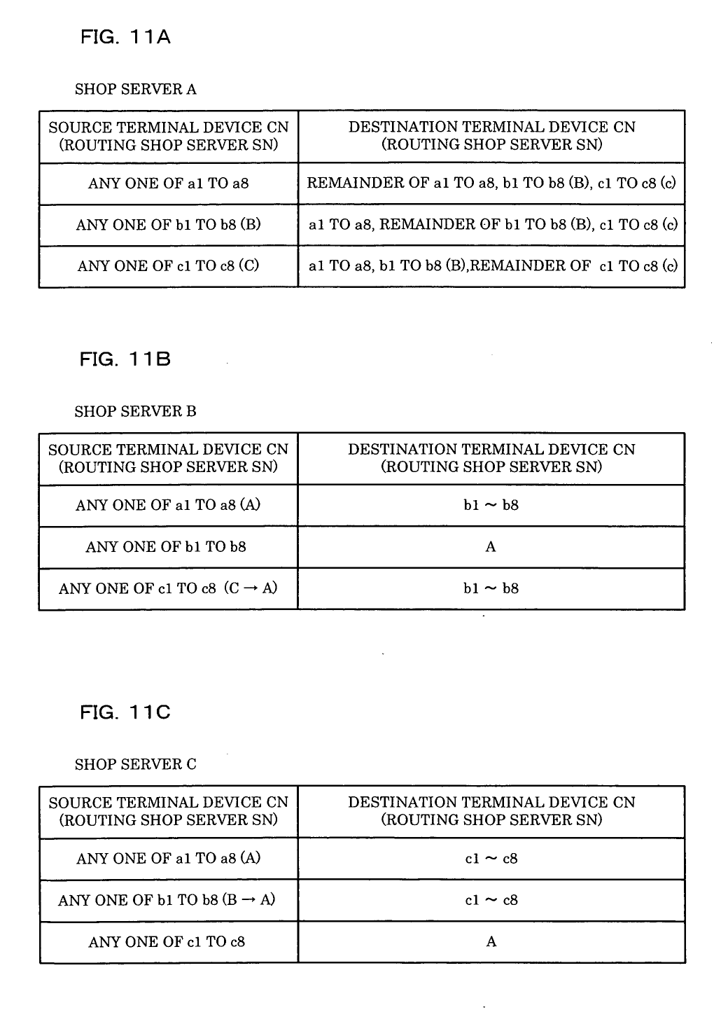

In a table shown in FIG. 11, the machine ID (CN) of the terminal device 1 which is the source of data received by the shop server 2 (shop server A, B, or C) and the shop server symbol (SN) of the shop server 2 through which data passes until that shop server 2 receives data are marked on the left side. On the right side of the table, the machine ID (CN) of the terminal device 1 which is the destination of data transmitted from the shop server 2 (shop server A, B, or C) and the shop server symbol (SN) of the shop server 2 through which data passes until that terminal device 1 receives data are marked. Moreover, the CPU 201 provided in the shop server A, B, or C updates various data stored in the predetermined area of the RAM 203 when receiving data transmitted from the terminal device 1 (for example, terminal device al) which is participating in the game.

The CPU 201 of the shop server A receives data from any one of the terminal devices a1 to a8 and transmits data to the remainder of the terminal devices a1 to a8, the shop servers B and C, as described in the second row from the top in the table. Then, the CPU 201 of the shop server B receives data from any one of the terminal devices a1 to a8 through the shop server A and transmits data to the terminal devices b1 to b8, as described in the second row from the top in the table. The CPU 201 of the shop server C receives data from any one of the terminal devices a1 to a8 through the shop server A and transmits data to the terminal devices c1 to c8, as described in the second row from the top in the table.

The CPU 201 of the shop server B receives data from any one of the terminal devices b1 to b8 and transmits data to the shop server A, as described in the third row from the top in the table. Then, the CPU 201 of the shop server A receives data from any one of the terminal devices b1 to b8 through the shop server B and transmits data to the terminal devices al to a8, the remainder of the terminal devices b1 to b8, and the terminal devices cl to c8, as described in the third row from the top in the table. The CPU 201 of the shop server C receives data from any one of the terminal devices b1 to b8 through the shop servers B and A, and transmits data to the terminal devices cl to c8, as described in the third row from the top in the table.

Similarly, the CPU 201 of the shop server C receives data from any one of the terminal devices c1 to c8 and transmits data to the shop server A, as described in the fourth row from the top in the table. Then, the CPU 201 of the shop server A receives data from any one of the terminal devices c1 to c8 through the shop server C and transmits data to the terminal devices a1 to a8, the terminal devices b1 to b8, and the remainder of the terminal devices c1 to c8, as described in the fourth row from the top in the table. The CPU 201 of the shop server B receives data from any one of the terminal devices c1 to c8 through the shop servers C and A, and transmits data to the terminal devices b1 to b8, as described in the fourth row from the top in the table.

In such a manner, among the shop servers A, B, and C, the CPU 201 transmits data from the respective terminal devices 1 and, whenever receiving data from the respective terminal devices 1, updates various data stored in the RAM 203. Thus, the respective terminal devices 1 progress the game by using data stored in the RAM 203, such that the time synchronization in the progress of the game among the respective terminal devices 1 (the coincidence of the game progress statuses) can be easily controlled. Moreover, in the invention, the message (chat message) is transmitted to only the terminal device 1 serving as the destination of that message. In this case, the communication of the message is not performed by means of the data communication method described with reference to FIG. 11.

That is, the shop server 2 that receives the participation in the game first (here, the shop server A) receives data from the terminal device 1, that is connected thereto via the private line 5, and transmits data to all other terminal devices 1. Further, the shop server 2 receives data from the terminal device 1, that is connected to another shop server 2 (here, the shop server B or C) via the private line 5, through another shop server 2 (the shop server B or C) and transmits data to all other terminal devices 1. Further, another shop server 2 (the shop server B or C) receives data from the terminal device 1, that is connected to the shop server 2 (the shop server A) via the private line 5, through the shop server 2 (the shop server A) and transmits data to the terminal device 1 connected thereto via the private line 5.

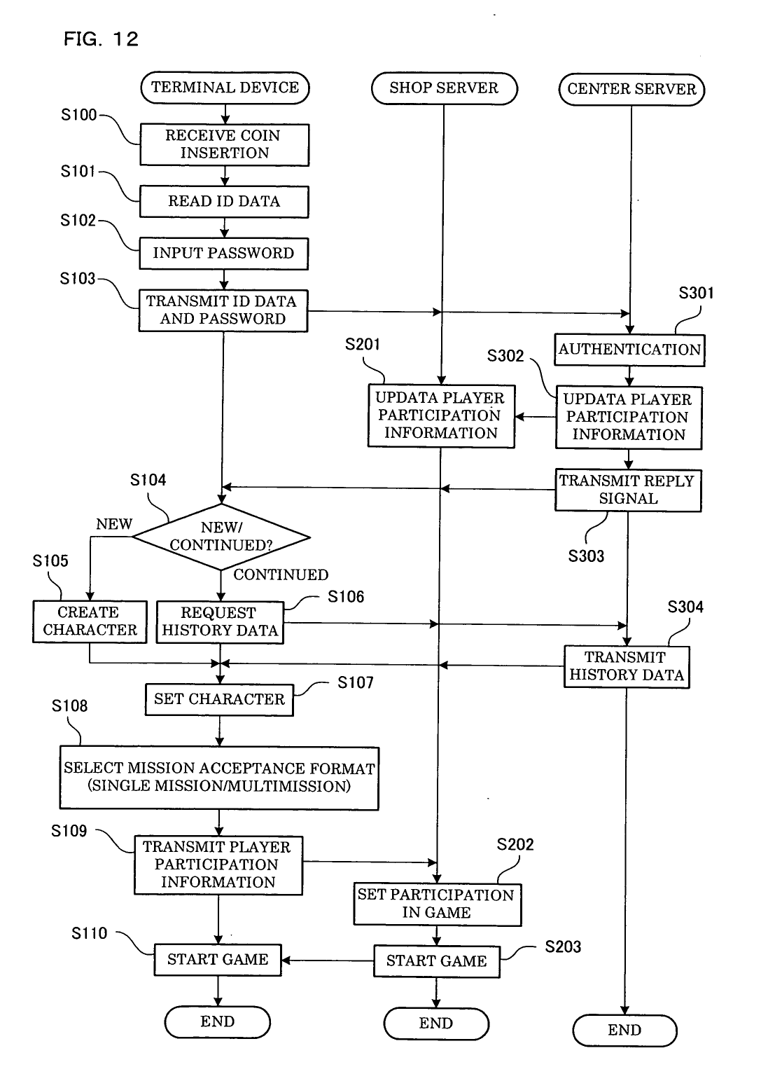

FIG. 12 is a flowchart showing the processing which is executed by the terminal device 1, the shop server 2, and the center server 3 until the game starts. First, the CPU 101 of the terminal device 1 receives the insertion of the coin into the coin insertion slot 15 (Step S100). When receiving the predetermined signal outputted from the coin sensor 115 at the time of the coin detection, the CPU 101 reads ID data of the player from the ID card 8 inserted into the ID card slot 16 by means of the ID card reader 116 (Step S101). Next, the CPU 101 receives the input of the password by the operation of the player (Step S102). Next, the CPU 101 transmits the read ID data to the center server 3 via the private line 5 by means of the communication interface circuit 104 to pass through the shop server 2, together with the password inputted by the operation of the player (Step S103).

The CPU 301 of the center server 3 determines whether or not there exists ID data received from the terminal device 1 in ID data stored in the RAM 303. If it is determined that there exists ID data, it is determined whether the password of the player stored in the RAM 303 correlated with that ID data matches with the password received from the terminal device 1, and thus the authentication is performed according to that determination result (Step S301). Moreover, at the time of the authentication, the CPU 301 refers to history data stored in the RAM 303 and determines whether the player is a player who plays the game newly or a player who plays the game continuously.

Then, the CPU 301 of the center server 3 updates the player participation information (see FIG. 10) stored in the RAM 303 (Step S302) and transmits that player participation information to the shop server 2 to update the player participation information stored in the RAM 203 of the shop server 2 (Step S201). Next, the CPU 301 of the center server 3 transmits the authentication result to the terminal device 1 as the reply signal (Step S303).

The CPU 101 of the terminal device 1 determines whether the player who starts the game is a player who plays the game newly or a player who plays the game continuously, based on the reply signal received from the center server 3 (Step S104).

In the step S104, if it is determined that the player who starts the game is a player who plays the game newly, the CPU 101 creates the character based on the operation of the player (Step S105). In this step, the player inputs the instruction to select the figure, ability, characteristic, and the like of the corresponding character (the character operated by the player) by using the touch panel 14 while seeing the image displayed on the first display 11. Then, the CPU 101 creates the character according to that instruction. Besides, the CPU 101 sets the level of a character corresponding to a player, who plays a game newly, to an initial value (for example, level 1). Next, the CPU 101 generates the player information (see FIG. 14) including multiple entries, such as the information regarding the player, the ability of the character, and the like, based on the result of the step S105 and stores the player information in the RAM 103, thereby setting the character (Step S107). Moreover, the player information shown in FIG. 14 represents the player information of all players who participate in the game, while the player information generated through this step represents only predetermined entries of one player.

On the other hand, in the step S104, if it is determined that the player who starts the game is a player who plays the game continuously, the CPU 101 transmits a signal purporting to request history data of that player to the center server 3via the private line 5 by means of the communication interface circuit 104 (Step S106). When receiving that signal from the terminal device 1, the center server 3 reads history data regarding that player from the RAM 303 and transmits history data to the terminal device 1 (Step S304).

History data shown in FIG. 13A is history data of the player and the character at that time (that is, player history data) and history data shown in FIG. 13B is history data representing the game status of the player (the character corresponding to the player) (that is, game history data). These history data is data which is updated at the predetermined timing (for example, when the mission is cleared, when the reward for the mission clear is received, when the monster is defeated, or the like).

In player history data, as shown in FIG. 13A, for example, there are entries, such as the ID data, name, and level of the player, the weapon, shield, or belonging of the character, money of the player, the skill level of the player, and the like. In game history data, as shown in FIG. 13B, there are multiple history data including various kinds of elements, such as the date when the mission is cleared, the participated players, the level at the time of the mission clear, the required time, and the acquired reward.

In the step S304, history data shown in FIGS. 13A and 13B are transmitted from the center server 3 to the terminal device 1. The CPU 101 of the terminal 1 that receives history data from the center server 3 generates the player information (see FIG. 14) including multiple entries, such as the information regarding the player, the ability of the character corresponding to the player, based on the history data and stores the player information in the RAM 103, thereby setting the character (Step S107). As regards the ability of the character, the CPU 101 refers to the ability setting table stored in the ROM 102 and determines the ability of the character based on the level of the player (the character corresponding to the player) included in history data. Moreover, the player information shown in FIG. 14 represents the player information regarding all players who participate in the game, while the player information generated through this step represent only the predetermined entries of one player.

After the step S107 is performed, the CPU 101 receives the selection of the mission acceptance format according to the operation of the player (Step S108). In this step, the player operates the touch panel 14 to input an instruction purporting to select any one of the single mode in which the player accepts the mission by himself and the multi mode in which the player accepts the mission together with other players, while seeing the image displayed on the first display 11. Then, the CPU 101 stores data according to the input instruction in a column for the mission acceptance format of the player information (see FIG. 14) stored in the RAM 103. Moreover, the player information shown in FIG. 14 represents the player information regarding all players who participate in the game, while data stored in the column for the mission acceptance format through this step is only data regarding one player.

Next, the CPU 101 the player information regarding one player stored in the RAM 103 transmits to the shop server 2 via the private line 5 by means of the communication interface circuit 104 (Step S109).

With the player information regarding one player, the CPU 201 of the shop server 2 performs the setting for allowing that player to participate in the game (Step S202). In this step, the CPU 201 adds the player information regarding one player received from the terminal device 1 to the player information stored in the RAM 203 in advance. In addition, the CPU 201 set a play field coordinate of the character corresponding to a player, who participates in the game newly, to the initial value (the value corresponding to the location of the guild) (see FIG. 14).

As shown in FIG. 14, in the RAM 203 of the shop server 2, the player information regarding multiple players (in the drawing, five players) is stored. The player information includes multiple entries and stores, for example, the information regarding the player and the information regarding the level, ability, and skill level of the character, and the like. In FIG. 14, in a column for the mission, information regarding a mission under setting at present is stored. Further, in the column for the mission acceptance format, data regarding which of the single mode and the multi mode is selected is stored. Further, in a column for the play field coordinate, data regarding a position at which the character exists in the virtual game space at that time is stored.

After the step S202 is performed, the terminal device 1 and the shop server 2 start the game, respectively (Steps S110 and S203). As shown in FIG. 12, the respective players can participate in the game, which is executed on the game system according to the present embodiment, at the desired time. Further, the multiple players can play the game simultaneously in the virtual game space. This is one of the features of the MMORPG. Further, during the progress of the game, as described with reference to FIG. 11, the data communication is made between the shop server 2 and the respective terminal devices participating in the game, thereby controlling the time synchronization. Therefore, in the RAM 203 of the shop server 2 and the RAMs 103 of the respective terminal devices 1, the same player information is stored constantly.

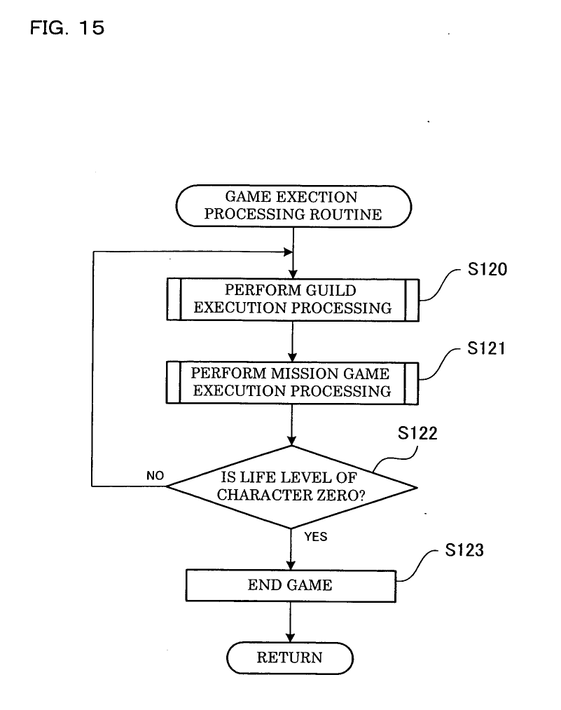

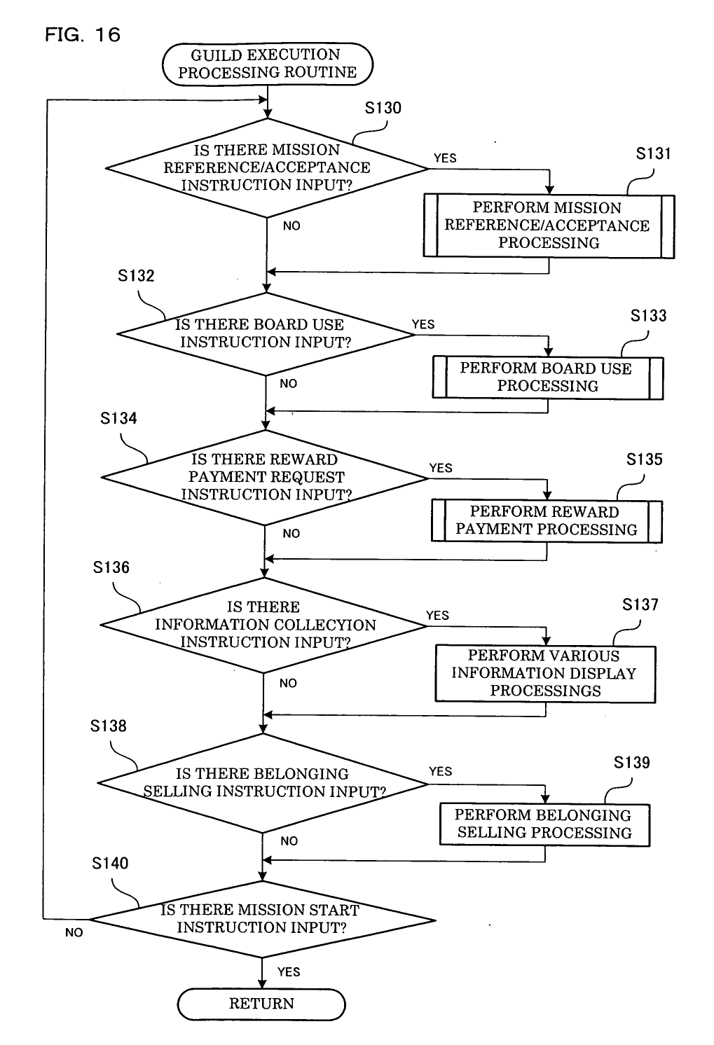

FIG. 15 is a flowchart showing a game execution processing routine that is executed by the terminal device 1. First, the CPU 101 of the terminal device 1 performs the guild execution processing (Step S120). The guild execution processing will be described below in detail with reference to FIG. 16, but, as shown in ST5 of FIG. 8, the mission reference and acceptance, the information collection, the reception of the reward for the mission clear, the use of the guild board, the selling of the item, or the like can be performed. In addition, the guild execution processing ends when the character accepts the mission and starts that mission.

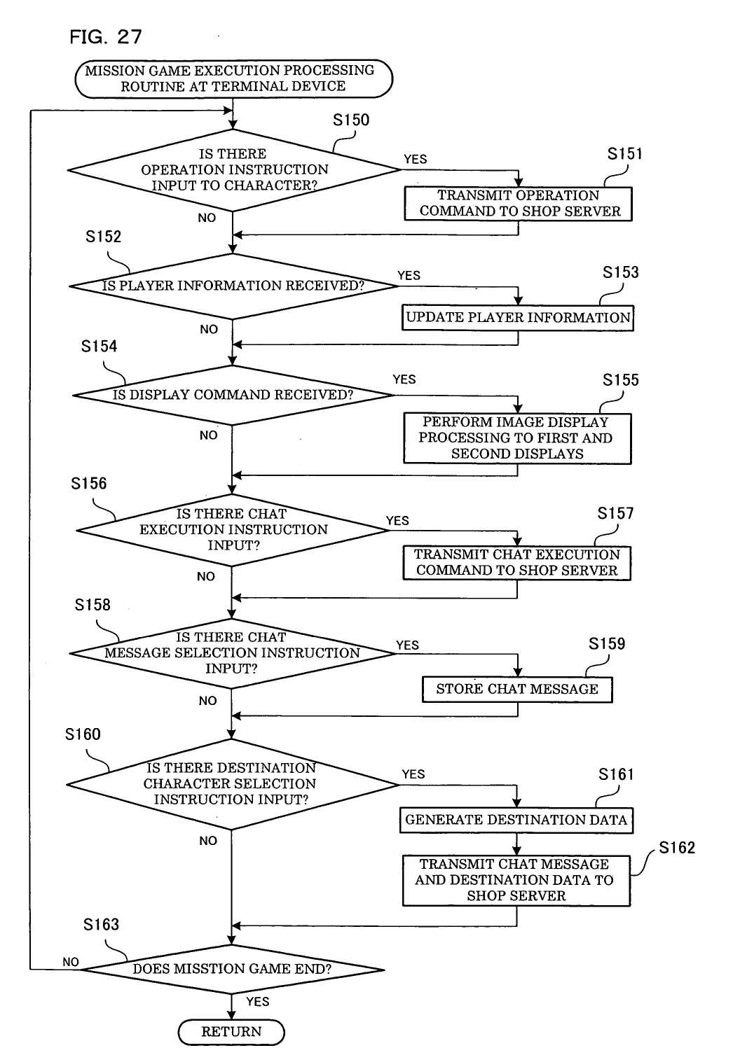

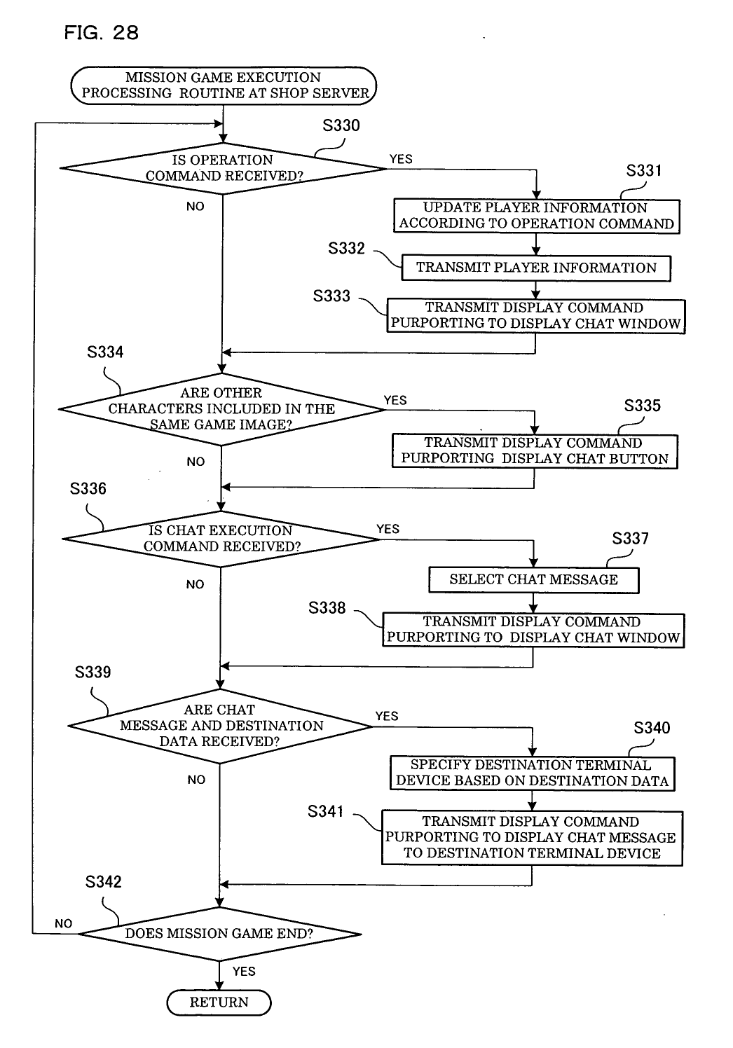

When the guild execution processing of the step S120 is completed, the CPU 101 performs a mission game execution processing (Step S121). The mission game execution processing will be described below in detail with reference to FIGS. 27 and 28. In summary, in the mission game execution processing, the player operates the corresponding character by using various buttons 118 and the operating lever 119 and makes an adventure in the virtual game space. Further, the player can communicate the chat messages with other players. The mission game execution processing ends when a predetermined condition for the mission completion is satisfied. As the condition for the mission completion, the mission clear, the return to the guild, the life level of the character of zero (0), or the like may be exemplified.

When the above-described condition for the mission completion is satisfied and thus the mission game execution processing of the step S121 is completed, the CPU 101 determines whether or not the life level of the character is zero (0) (Step S122). If it is determined that the life level of the character is zero (0), since the character cannot continue to play the game, various steps (for example, the generation of history data based on the player information, the transmission of history data to the center server 3, and the like) for ending the game are performed (Step S123) and the present subroutine ends.

On the other hand, in the step S122, if it is determined that the life level of the character is not zero (0), since other conditions for the mission completion (for example, the mission clear, the return to the guild, and the like) are satisfied, the process returns to the guild execution processing of the step S120. Therefore, in the game execution processing, until the life level of the character is zero (0), the guild execution processing of the step S120 and the mission game execution processing of the step S121 are executed repeatedly. Of course, though not shown in the drawing, when an instruction purporting to end the game by the player is inputted, the steps for ending the game of the step S123 are executed, regardless of whether or not the life level of the character, is zero (0) and the present subroutine ends.

Next, the guild execution processing routine that is executed through the step S120 of FIG. 15 will be described with reference to FIG. 16.

When the guild execution processing is executed, an image shown in FIG. 17A is displayed on the first display 11 by the first drawing processing section 111. An image representing the present location of the character, which is called ‘GUILD, is disposed on the upper left side of the screen and an image representing an instruction to the player of ‘PLEASE SELECT ONE’ is disposed on the upper right side of the screen. Images representing selections of ‘MISSION REFERENCE/ACCEPTANCE’, ‘BOARD’, ‘REWARD’, ‘INFORMATION COLLECTION’, and ‘BELONGING SELLING’ are sequentially from the top at the center of the screen. The player contacts any one of the images representing the selections through the touch panel 14 so as to input the instruction according to that selection.

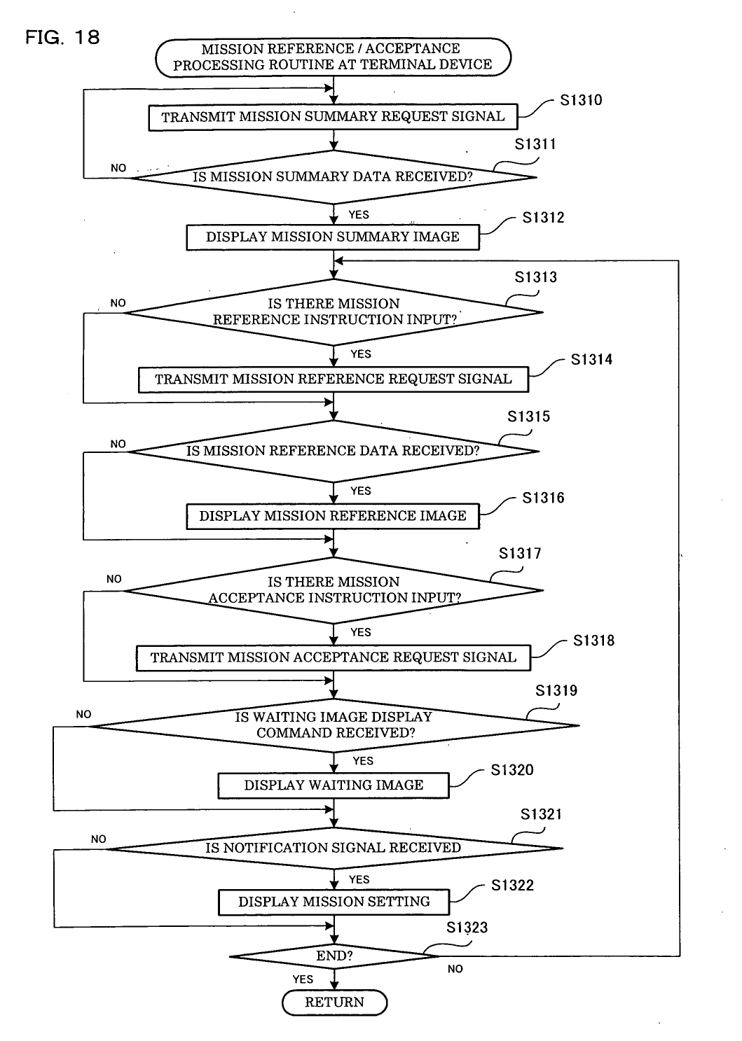

If the guild execution processing routine is executed, first, the CPU 101 determines whether or not the mission reference/acceptance instruction is inputted (Step S130). This instruction is inputted when the player contacts the image representing the selection of ‘MISSION REFERENCE/ACCEPTANCE’ through the touch panel 14. If it is determined that the mission reference/acceptance instruction is inputted, the CPU 101 executes a mission reference/acceptance processing (Step S131). The mission reference/acceptance processing will be described with reference to FIG. 18. In the mission reference/acceptance processing, when the player accepts the mission, as shown in FIGS. 17A and 17B, the selection of ‘MISSION REFERENCE/ACCEPTANCE’ displayed on the first display 11 is changed into a selection of ‘MISSION START’.

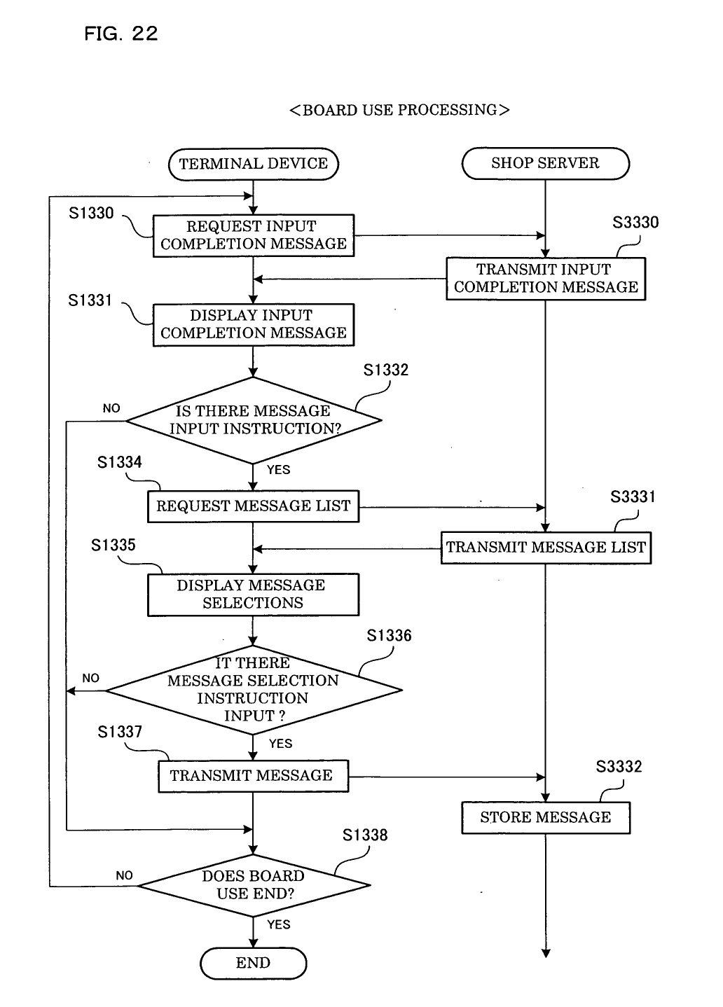

Next, the CPU 101 determines whether or not the board use instruction is inputted (Step S132). This instruction is inputted when the player contacts the image representing the selection of ‘BOARD’ through the touch panel 14. If it is determined that the board use instruction is inputted, the CPU 101 executes a board use processing (Step S133). The board use processing will be described below in detail with reference to FIG. 22.

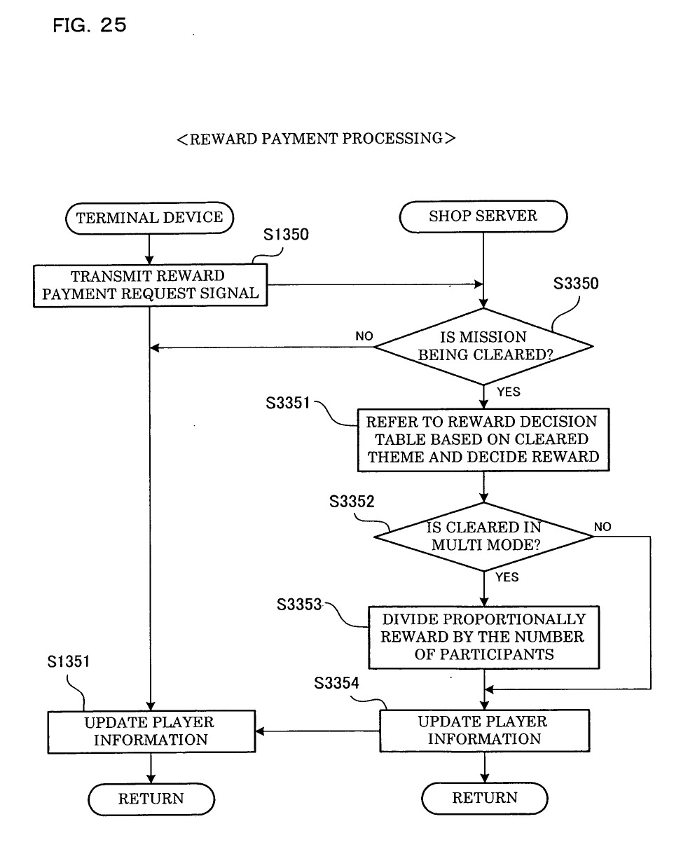

Next, the CPU 101 determines whether or not the reward payment request instruction is inputted (Step S134). This instruction is inputted when the player contacts the image representing the selection of ‘REWARD’ through the touch panel 14. If it is determined that the reward payment request instruction is inputted, the CPU 101 executes a reward payment processing (Step S135). The reward payment processing will be described in detail with reference to FIG. 25.

Next, the CPU 101 determines whether or not the information collection instruction is inputted (Step S136). This instruction is inputted when the player contacts the image representing the selection of ‘INFORMATION COLLECTION’ through the touch panel 14. If it is determined that the information collection instruction is inputted, various information display processings are performed (Step S137). In these processings, the CPU 101 obtains the information (for example, the information regarding other characters or missions), which is selected from the ROM 203 when the CPU 201 of the shop server 2 executes the program stored in the ROM 202, from the shop server 2 and, based on the information, causes the first display 11 to display the image representing the information by the first drawing processing section 111.

Next, the CPU 101 determines whether or not the belonging selling instruction is inputted (Step S138). This instruction is inputted when the player contacts the image representing the selection of ‘BELONGING SELLING’ through the touch panel 14. If it is determined that the belonging selling instruction is inputted, a belonging selling processing is performed (Step S139). In this processing, when the player selects the belonging to be sold at the guild among the belongings of the character, the corresponding instruction is transmitted to the shop server 2. Then, the CPU 201 of the shop server 2 increases the money of the player information stored in the RAM 203 and deletes data regarding the target belonging. On the other hand, when the player selects an item on sale at the guild, the corresponding instruction is transmitted to the shop server 2. Then, the CPU 201 of the shop server 2 decreases the money of the player information stored in the RAM 203 and adds data of the target item.

Next, the CPU 101 determines whether or not the mission start instruction is inputted (Step S140). This instruction is inputted when an image shown in FIG. 17B is displayed on the first display 11 and the player contacts the image representing the selection of ‘MISSION START’ through the touch panel 14. If it is determined that the mission start instruction is inputted, the present subroutine ends. On the other hand, if it is determined that the mission start instruction is not inputted, the process returns to the step S130.

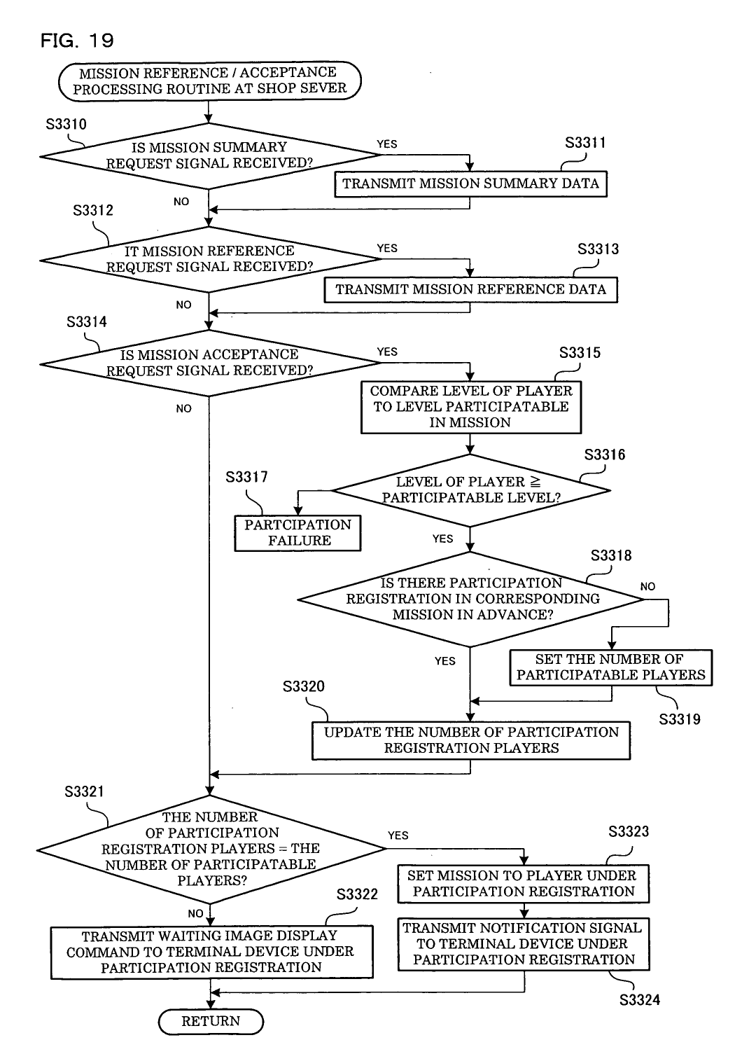

FIG. 18 is a flowchart showing the mission reference/acceptance processing routine that is executed through the step S131 of FIG. 16. FIG. 19 is a flowchart showing a processing that is executed by the shop server 2 corresponding to the routine of FIG. 18 executed by the terminal device 1.

First, the CPU 101 of the terminal device 1 transmits a mission summary request signal to the shop server 2 via the private line 5 by means of the communication interface circuit 104 (Step S1310). This step corresponds to a step S3310 of FIG. 19 and the CPU 201 of the shop server 2 extracts mission summary data regarding a mission, in which the player can participate at present, from mission summary data stored in the ROM 202 and transmits that mission summary data to the terminal device 1, when receiving the mission summary request signal from the terminal device 1.

FIG. 20 is a diagram showing an example of mission summary data. In a leftmost column, the mission code (for example, “AA”, “AB”, or the like) constituted by a two-digit signal allocated to each mission is stored. Further, in a right column, the number of participatable players in each mission is stored. As for the number of participatable players, “1” is stored as the number of participatable players in the signal mode and “4” is stored as the number of participatable players in the multi mode.

In the present embodiment, the case in which the number of participatable players is 1 in the single mode and the number of participatable players is 4 in the multi mode is described. However, the invention is not limited to this example. For example, there may be a mission in which the number of participatable players in the single mode is zero (0). In this case, since the player cannot participate in the mission in the single mode, the multi mode has to be selected. Further, the number of participatable players in the multi mode is not particularly limited.

The content of the mission “AA” is ‘WANT TO DELIVER CARGO TO MR. XX’ and the participatable level is 1. Moreover, the participatable level is the minimum level required for accepting that mission. A player who does not reach that level cannot accept that mission. The content of the mission “AB” is ‘WANT TO GUARD PRINCESS ●● FROM MONSTER ΔΔ’ and the participatable level is 3. The content of the mission “AC” is ‘WANT TO INVESTIGATE OO CAVERN AND FIND TREASURE’ and the participatable level is 5. The content of the mission “AD” is ‘WANT TO INVESTIGATE ISOLATED ISLAND □□ AND FIND TREASURE’ and the participatable level is 7. The content of the mission “AE” is ‘WANT TO INVESTIGATE ANCIENT RUINS AND UNRAVEL MYSTERY OF ▪▪ ’ and the participatable level is 9. The content of the mission “AF” is ‘INVESTIGATE UNPRECEDENTED LAND’ and the participatable level is 11. The difficulties of the missions are set to increase in an order of the missions “AA” to “AF” and the participatable levels are set to increase in an order of the difficulties of the missions. Of course, the mission (condition) of the invention is not limited to them. A mission is not particularly limited as long as it can be set on the game.

After the step S1310, the CPU 101 determines whether or not mission summary data is received from the shop server 2 (Step S1311). If it is determined that mission summary data is not received, the process returns to the step S1310. On the other hand, if it is determined that mission summary data is received from the shop server 2, the CPU 101 controls the first drawing processing section 111 and causes the first display 11 to display an image shown in FIG. 21A (Step S1312).

FIG. 21A is a diagram showing an example of images displayed on the first display 11 when the step S1312 is performed. An image representing the present location of the character which is called ‘GUILD’ is disposed on the upper left side of the screen and an image representing the instruction to the player of ‘WHICH MISSION’ is disposed on the upper right side of the screen. Images representing the contents of the missions of ‘DELIVER CARGO TO MR. XX’, ‘GUARD PRINCESS ●● FROM ΔΔ’, ‘TREASURE OF OO CAVERN’, ‘INVESTIGATION OF ISOLATED ISLAND □□’, and ‘MYSTERY OF ANCIENT RUINS’ are disposed sequentially from the top at the center of the screen. Further, images representing selections of ‘REFER’ and ‘ACCEPT’ are disposed to correspond to the respective missions. The player contacts any one of the images representing the selections through the touch panel 14 so as to input the instruction according to the corresponding selection. For example, the player contacts the image representing the selection of ‘REFER’ corresponding to the ‘TREASURE OF OO CAVERN’ through the touch panel 14 so as to obtain information regarding ‘TREASURE OF OO CAVERN’. Further, the player contacts the image representing the selection of ‘ACCEPT’ corresponding to the ‘TREASURE OF OO CAVERN’ through the touch panel 14 so as to accept the mission ‘TREASURE OF OO CAVERN’.

After the step S1312, the CPU 101 determines whether or not the mission reference instruction is inputted (Step S1313). This instruction can be inputted when the player contacts the image representing the selection of ‘REFER’ through the touch panel 14. If it is determined that the mission reference instruction is inputted, the CPU 101 a mission reference request signal to the shop server 2 via the private line 5 by means of the communication interface circuit 104 (Step S1314). This step corresponds to the step S3312 of FIG. 19. The shop server 2 that receives the mission reference request signal from the terminal device 1 extracts mission reference data regarding the target mission from mission reference data (for example, data that describes the content of the mission in detail, motion pictures or still images representing the content, or the like) stored in the ROM 202 and transmits mission reference data to the terminal device 1.

In the step S1313, if it is determined that the mission reference instruction is not inputted or if the step S1314 is performed, next, the CPU 101 determines whether or not mission reference data is received (Step S1315). If it is determined that mission reference data is received, the CPU 101 controls the first drawing processing section 111 and causes the first display 11 to display an image shown in FIG. 21B (Step S1316).

FIG. 21B is a diagram showing an example of images displayed on the first display 11 when the step S1316 is performed. An image representing the present location of the character which is called ‘GUILD’ is disposed on the upper left side of the screen and an image representing the name of the mission to be referred to of ‘ON TREASURE OF OO CAVERN’ is disposed on the upper right side of the screen. An image representing an entrance of the OO cavern is disposed on the left side of the screen. On the right side, an image representing a message for illustrating the content of the mission is disposed and images representing the selections of ‘ACCEPT’ and ‘RETURN’ are also disposed.

In the step S1315, if it is determined that mission reference data is not received from the shop server 2 or if the step S1316 is executed, the CPU 101 determines whether or not the mission acceptance instruction is inputted (Step S1317) This instruction can be inputted when the player contacts the image representing the selection of ‘ACCEPT’ through the touch panel 14. If it is determined that the mission acceptance instruction is inputted, the CPU 101 transmits a mission acceptance request signal to the shop server 2 via the private line 5 by means of the communication interface circuit 104 (Step S1318). This step corresponds to the step S3314 of FIG. 19.

In the step S1317, if it is determined that the mission acceptance instruction is not inputted or if the step S1318 is executed, the CPU 101 determines whether or not a waiting image display command is received from the shop server 2 (Step S1319). This step corresponds to the step S3322 of FIG. 19. In the waiting image display command, data regarding the number of participatable players and the number of participation registration players to the mission is included.

In the step S1319, if it is determined that the waiting image display command is received, the CPU 101 controls the first drawing processing section 111 based on the waiting image display command (Step S1320). The first drawing processing section 111 extracts predetermined image data from the ROM 102 based on data regarding the number of participatable players and the number of participation registration players included in the above-described waiting image display command and stores these image data in the video RAM according to a predetermined priority, thereby generating a waiting image. Next, the first drawing processing section 111 outputs the waiting image to the first display 11. As a result, an image shown in FIG. 21C is displayed on the first display 11.

FIG. 21C is a diagram showing an example of images displayed on the first display 11 when the step S1320 is performed. An image representing the present location of the character which is called ‘GUILD’ is disposed on the upper left side of the screen and an image representing the name of the mission of ‘TREASURE OF OO CAVERN’ is disposed on the upper right side of the screen. Further, an image representing that the number of participatable players is 4 and the number of participation registration players is 3 is disposed at the center of the screen.

In the step S1319, if it is determined that the waiting image display command is not received from the shop server 2 or if the step S1320 is executed, next, the CPU 101 determines whether or not a notification signal is received from the shop server 2 (Step S1321). This step corresponds to the step S3324 of FIG. 19.

In the step S1321, if it is determined that the notification signal is received, the CPU 101 controls the first drawing processing section 111 and causes the first display 11 to display an image representing a purport that the mission is set, as shown in FIG. 21D (Step S1322).

FIG. 21D is a diagram showing an example of images displayed on the first display 11 when the step S1322 is performed. An image representing the present location of the character which is called ‘GUILD’ is disposed on the upper left side of the screen and an image representing the name of the accepted mission of ‘TREASURE OF OO CAVERN’ is disposed on the upper right side of the screen. On the left side of the screen, an image representing the entrance of the OO cavern is disposed. On the right side of the screen, an image representing a purport that the mission is accepted is disposed.

In the step S1321, if it is determined that the notification signal is not received or if the step S1322 is executed, the CPU 101 determines whether to end the mission reference/acceptance processing or not (Step S1323). The mission reference/acceptance processing ends when an instruction purporting to return to the subroutine of FIG. 16 after the processing is completed is inputted through the touch panel 14. In the step S1323, if it is determined to end the mission reference/acceptance processing, the present subroutine ends. On the other hand, if it is determined not to end the mission reference/acceptance processing, the process progresses to the step S1313.

Next, the flowchart shown in FIG. 19 will be described. First, the CPU 201 of the shop server 2 determines whether or not the mission summary request signal is received from the terminal device 1 (Step S3310). This step corresponds to the step S1310 of FIG. 18. If it is determined that the mission summary request signal is received from the terminal device 1, the CPU 201 of the shop server 2 extracts mission summary data regarding a mission, in which the player can participate at present, from mission summary data stored in the ROM 202 and transmits mission summary data to the terminal device 1 (Step S3311). This step corresponds to the step S1311 of FIG. 18. Then, a mission summary image (see FIG. 21A) is displayed on the first display 11 of the terminal device 1 that receives mission summary data (see FIG. 18) (Step S1312).

In the step S3310, if it is determined that the mission summary request signal is not received or if the step S3311 is executed, the CPU 201 of the shop server 2 determines whether or not a mission reference request signal is received from the terminal device 1 (Step S3312). This step corresponds to the step S1314 of FIG. 18.

In the step S3312, if it is determined that the mission reference request signal is received from the terminal device 1, the CPU 201 extracts mission reference data regarding the target mission from mission reference data stored in the ROM 202 and transmits that mission reference data to the terminal device 1 (Step S3313). This step corresponds to the step S1315. A mission reference image (see FIG. 21B) is displayed on the first display 11 of the terminal device 1 that receives mission reference data (FIG. 18) (Step S1316).

In the step S3312, if it is determined that the mission reference request signal is not received or if the step S3313 is executed, the CPU 201 determines whether or not a mission acceptance request signal is received (Step S3314). This step corresponds to the step 1318 of FIG. 18.

In the step S3314, if it is determined that the mission acceptance request signal is received, the CPU 201 of the shop server 2 compares the level of the player included in the player information (see FIG. 14) stored in the RAM 203 and the participatable level included in mission summary data (see FIG. 20) stored in the ROM 202 (Step S3315). Next, the CPU 201 determines whether or not the level of the player is equal to or more than the participatable level of the mission based on the comparison result in the step S3315 (Step S3316). For example, in the player information shown in FIG. 14, the player “DDD” has the level of 11, such that he can participate in the mission “AB” the participatable level of which is 3. However, since the player “AAA” has the level of 1, such that he cannot participate in the mission “AB”.

In the step S3316, if it is determined that the level of the player is not equal to or more than the participatable level of the mission, the CPU 201 does not perform the participation registration of that player in the mission (Step S3317) and the process progresses to the step S3321.

On the other hand, in the step S3316, if it is determined that the level of the player is equal to or more than the participatable level of the mission, the CPU 201 determines whether or not other players perform the participation registration in that mission in advance (Step S3318). If it is determined that other players do not perform the participation registration in that mission yet, the CPU 201 refers to mission summary data stored in the ROM 202 and stores the number of participatable players in that mission in the RAM 203, thereby setting the number of participatable players in that mission (Step S3319). For example, when that player selects the single mode, data representing a purport that the number of participatable players is “1” is stored in the RAM 203. Further, when that player selects the multi mode, data representing a purport that the number of participatable players is “4” is stored in the RAM 203.

In the step S3318, if it is determined that other players perform the participation registration in that mission in advance or if the step S3319 is executed, the CPU 201 updates the number of participation registration players (Step S3320). When the step S3319 is executed, in the step 3320, the CPU 201 stores in the RAM 203 data representing a purport that the number of participation registration players in that mission is “1”. On the other hand, when other players perform the participation registration in that mission in advance, since data representing the number of participation registration players in that mission is stored in the RAM 203, in the step S3320, the CPU 201 updates the number of participation registration players stored in the RAM 203 by adding 1 thereto.

In the step S3314, if it is determined that the mission acceptance request signal is not received or if the step S3320 is executed, the CPU 201 determines whether or not the number of participation registration players in the mission that is sequentially updated (1 addition) whenever the step S3320 is performed is equal to the number of participatable players in the mission set through the step S3319 (Step S3321). When the single mode is selected, since the number of participatable players is set to “1” in the step S3319 and the number of participation registration players in the mission of “1” is stored in the RAM 203 in the step S3320, the determination in the step S3321 becomes “YES”. Further, when the multi mode is selected, since the number of participatable players is set to “4” in the step S3319 and the number of participation registration players in the mission of “1” is stored in the RAM 203 in the step S3320, the determination in the step S3321 becomes “NO”. Subsequently, the step S3320 is performed repeatedly and, when the number of participation registration players in the mission becomes “4”, the determination in the step S3321 becomes “YES”.

In the step S3321, if it is determined that the number of participation registration players is not equal to the number of participatable players, the CPU 201 of the shop server 2 transmits the waiting image display command including data about the number of participation registration players and the number of participatable players to the terminal device 1 that is registering for participation (Step S3322). This step corresponds to the step S1319 of FIG. 18. The waiting image (see FIG. 21C) is displayed on the first display 11 of the terminal device 1 that receives the waiting image display command (FIG. 18) (Step S1320). Then, the present subroutine ends.

On the other hand, in the step S3321, if it is determined that the number of participation registration players is equal to the number of participatable players, the CPU 201 of the shop server 2 updates data of the column for the mission of the player information (see FIG. 14) stored in the ROM 203 and sets the mission to the player who is registering for participation (Step S3323). Next, the CPU 201 transmits to the terminal device 1, which is registering for participation, the notification signal representing a purport that the mission is set (Step S3324). This step corresponds to the step S1321 of FIG. 18. An image (see FIG. 21D) representing the purport that the mission is set is displayed on the first display 11 of the terminal device 1 that receives the notification signal (FIG. 18) (Step S1322). Then, the present subroutine ends.

FIG. 22 is a flowchart showing a board use processing which is executed through the step S133 of FIG. 16 and a processing which is executed by the shop server corresponding to the board use processing.

First, the CPU 101 of the terminal device 1 transmits a request signal purporting to request an input completion message to the shop server 2 (Step S1330). The request signal purporting to request the input completion message is sent when a predetermined game input is made from a game terminal, for example, when the player contacts an image of ‘BOARD’ through the touch panel 14. When receiving the request signal, the shop server 2 transmits a message (input completion message), which is inputted by the terminal device 1 and is stored in the RAM 203 in advance, to the terminal device 1 serving as the source of the request signal (Step S3330).

When receiving the input completion message from the shop server 2, the terminal device 1 causes the first display 11 to display an image representing the input completion message shown in FIG. 24A by means of the first drawing processing section 111 (Step S1331).

FIG. 24A is a diagram showing an example of images displayed on the first display 11 of the terminal device 1 when the step S1331 of FIG. 22 is executed. An image representing the present location of the character which is called ‘GUILD’ is disposed on the upper left side of the screen and an image of ‘BOARD’ is disposed on the upper right side of the screen. On the right side, an image representing a selection of ‘NEW INPUT’ is disposed. ‘NEW INPUT’ is the selection that is used to input a message newly, not to input a message to a message of any other player. The player contacts the image of ‘NEW INPUT’ through the touch panel 14 so as to input an instruction purporting to input a message newly.

At the center of the screen, the input completion message inputted by each player is displayed. For example, an image of ‘AAA—‘MY NAME IS AAA. I'M PLEASED TO MEET YOU.’’ represents a message of ‘MY NAME IS AAA. I'M PLEASED TO MEET YOU.’ inputted by the player “AAA”. Further, on the left side thereof, an image representing a selection of ‘COMMENT’ is disposed. ‘COMMENT’ is the selection that is used to input a message to a message of any other player, not to input a message newly. The player contacts the image of ‘COMMENT’ through the touch panel 14 so as to input an instruction purporting to input a message to any other player. Further, an image ‘DDD—‘MY NAME IS DDD. I'M PLEASED TO MEET YOU.’’ disposed just below represents a message of ‘MY NAME IS DDD. I'M PLEASED TO MEET YOU.’ inputted by the player “DDD”. On the lower side of the message of the player “DDD”, an image of ‘BBB—‘WHY DON'T YOU ADVENTURE WITH ME?’’ and an image of ‘CCC—‘WHY DON'T YOU ADVENTURE WITH ME?’’ are disposed. These are the messages inputted by the players “BBB” and “CCC” to search a player who participates in the mission together with them, respectively.

After the step S1331, the CPU 101 determines whether or not an instruction purporting to input a message is inputted (Step S1382). The instruction purporting to input a message can be inputted when the player contacts the image of ‘NEW INPUT’ or ‘COMMENT’ through the touch panel 14.

In the step S1332, if it is determined that the instruction purporting to input a message is inputted, the CPU 101 of the terminal device 1 transmits a request signal purporting to request a message list to the shop server 2 (Step S1334). The CPU 201 of the shop server 2 that receives the request signal extracts the message list stored in the ROM 202 and transmits the extracted message list to the terminal device 1 serving as the source of the request signal (Step S3331).

FIG. 23 is a diagram showing an example of a message list which is used when the step S1334 of FIG. 22 is performed. In the left column, a message number is stored and, in the right column, a message corresponding to each number is stored. For example, a message of ‘MY NAME IS “AAA (the player name)”. I'M PLEASED TO MEET YOU.’ is correlated with the number “001”. Further, a message of ‘WHY DON'T YOU ADVENTURE WITH ME?’ is correlated with the number “002”. In addition, a message of ‘LET'S ADVENTURE TOGETHER.’ is correlated with the number “003”. Though not shown in the drawing, in this message list, multiple messages are stored, in addition to the above-described messages.

The CPU 101 of the terminal device 1 that receives the message list from the shop server 2 controls the first drawing processing section 111 based on the message list and causes the first display 11 to display a message selection for selecting any one message of the multiple messages (Step S1335).

FIG. 24B shows an image displayed on the first display 11 when an image shown in FIG. 24A is displayed on the first display 11 and when the player “AAA” inputs an instruction purporting to input a message to a message of the player “BBB” through the touch panel 14. On the upper left side of the screen, the image representing the present location of the character of ‘GUILD’ is disposed. On the upper right side of the screen, the image of ‘BOARD’ is disposed. Below the images, an image of the message of the player “BBB” which is the input target of the message of the player “AAA” is disposed. In addition, below the image representing the message of the player “BBB”, the message list in which multiple selections representing the messages are arranged vertically is displayed. When the image shown in FIG. 24B is displayed, the player contacts the image representing the input message through the touch panel 14 so as to input an instruction to transmit the corresponding message to the shop server 2.

After the step S1335, the CPU 101 determines whether or not the instruction to select the message is inputted (Step S1336). This instruction can be inputted when the player contacts any one selection of the multiple selections representing the messages through the touch panel 14 when the image shown in FIG. 24B is displayed on the first display 11.

In the step S1336, if it is determined that the instruction to select the message is inputted, the CPU 101 transmits the corresponding message to the shop server 2 via the private line 5 by means of the communication interface circuit 104 (Step S1337). On the other hand, when receiving the message from the terminal device 1, the CPU 201 of the shop server 2 stores that message in the RAM 203 (Step S3332). Here, the message stored in the RAM 203 becomes the message that is communicated between the terminal device 1 and the shop server 2 in the above-described step S1330, S1331, or S3330 and that is displayed on the first display 11 of the terminal device 1, that is, the input completion message.

Then, the CPU 101 of the terminal device 1 determines whether to end the board use processing or not (Step S1338). The board use processing ends when an instruction purporting to return to the subroutine of FIG. 16 after the processing is completed is inputted through the touch panel 14. In the step S1338, if it is determined to end the board use processing, the present subroutine ends. On the other hand, if it is determined not to end the board use processing, the process returns to the step S1330. Then, the CPU 101 transmits the request signal purporting to request the input completion message again (Step S1330). The shop server 2 that receives that request signal transmits the input completion message to the terminal device 1 (Step S3330). Then, the terminal device 1 that receives the input completion message from the shop server 2 causes the first display 11 to display the input completion message (Step S1331).

FIG. 24C shows an image displayed on the first display 11 of the terminal device 1 when the image shown in FIG. 24B is displayed on the first display 11 and when the player contacts the image of ‘LET'S ADVENTURE TOGETHER.’ through the touch panel 14. Unlike the image shown in FIG. 24A, the image shown in FIG. 24C is displayed with the message of ‘LET'S ADVENTURE TOGETHER.’ inputted by the player “AAA” to the message of the player “BBB” added thereto.

FIG. 25 is a flowchart showing a reward payment processing which is executed through the step S135 of FIG. 16 and a processing which is executed by the shop server corresponding to the reward payment processing. First, the CPU 101 of the terminal device 1 transmits a reward payment request signal to the shop server 2 (Step S1350). When receiving the reward payment request signal from the terminal device 1, the CPU 201 of the shop server 2 determines whether or not the player clears the mission, based on the player information (see FIG. 14) stored in the RAM 203 (Step S3350). In the step S3350, if it is determined that the player clears the mission, the CPU 201 of the shop server 2 refers to the reward decision table and decides the reward based on the kind of the cleared mission, the level of the player, and the mission acceptance format (the number of participants in the mission) (Step S3351).

As shown in FIG. 26, in the left column of the reward decision table, the mission code constituted by a two-digit signal is stored. In the right column thereof, the reward corresponding to that mission is stored. For example, the reward corresponding to the mission “AA” is 100 and the reward corresponding to the mission “AB” is 300.

After the step S3351, the CPU 201 refers to the player information (see FIG. 14) stored in the RAM 203 and determines whether or not the player clears the mission in the multi mode (Step S3352). If it is determined that the mission is cleared in the multi mode, the reward decided through the step S3351 is divided proportionally by the number of participants in the mission (Step S3353). For example, when four players participate in the mission “AA”, the reward becomes 25.

In the step S3352, if it is determined that the player clears the mission in the single mode, not in the multi mode, or if the step S3353 is executed, the CPU 201 updates the player information (see FIG. 14) stored in the RAM 203 (Step S3354). Specifically, data of the column for the mission is cleared and the amount of money is increased by the reward. The CPU 101 of the terminal device 1 updates the player information in synchronization with the updated player information in the shop server 2 (Step S1351).

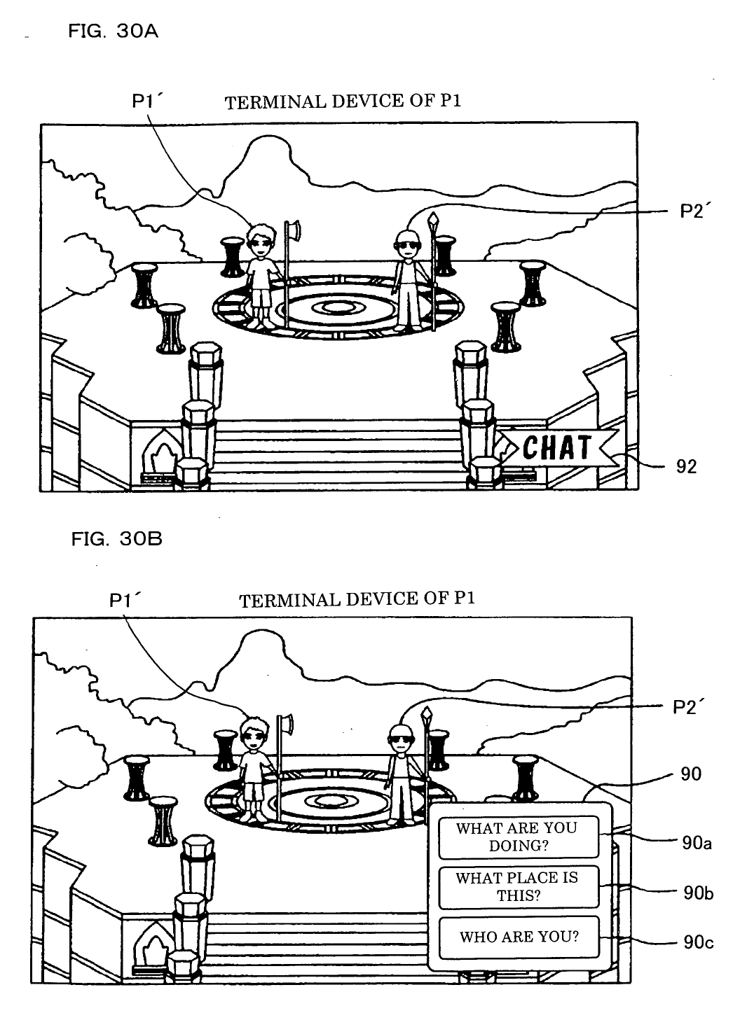

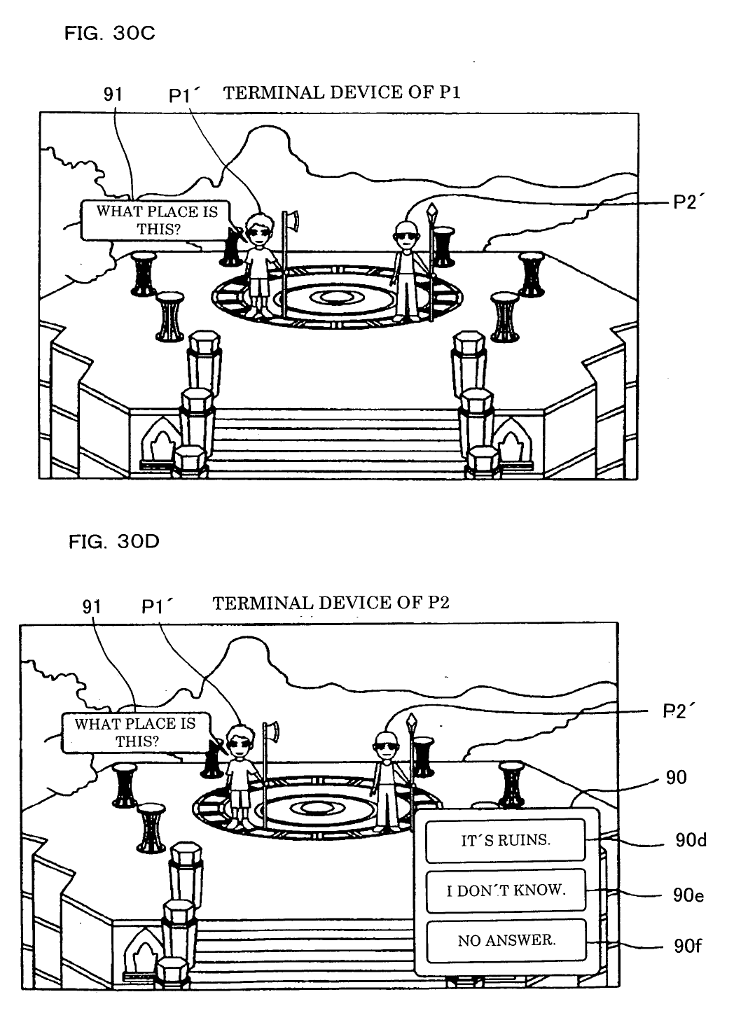

Next, a mission execution processing routine which is executed through the step S121 of FIG. 15 will be described with reference to FIG. 27. FIG. 28 is a flowchart showing a processing which is executed by the shop server corresponding to the routine of FIG. 27 executed by the terminal device. FIGS. 30A to 30D are diagrams showing examples of images displayed on the first display 11 of the terminal device 1 when the processings shown in FIGS. 27 and 28 are executed.

First, the CPU 101 of the terminal device 1 determines whether or not an operation instruction to the character is inputted (Step S150). The operation instruction to the character can be inputted when the player operates various buttons 118 or the operating lever 119. When the operation instruction to the character is inputted, the CPU 101 transmits an operation command to the shop server 2 (Step S151). This step corresponds to the step S330 of FIG. 28.

In the step S150, if it is determined that the operation instruction to the character is not inputted or if the step S151 is executed, the CPU 101 determines whether or not the player information is received from the shop server 2 (Step S152). This step corresponds to the step S332 of FIG. 28. If it is determined that the player information is received, based on that player information, the CPU 101 updates the player information stored in the RAM 103 (Step S153).

In the step S152, if it is determined that the player information is not received from the shop server 2 or if the step S153 is executed, the CPU 101 determines whether or not a display command is received from the shop server 2 (Step S154) This step corresponds to the step S333, S335, S338, or S341 of FIG. 28.

In the step S154, if it is determined that the display command is received, the CPU 101 executes an image display processing to the first display 11 or the second display 12 (Step S155). In this step, the CPU 101 supplies the display command to the first drawing processing section 111 or the second drawing processing section 112. The first drawing processing section 111 refers to the player information (see FIG. 14) stored in the RAM 103 and extracts image data from the ROM 102 according to the display command. Then, according to the display priority (for example, in an order of background images, monster images, and character images) on the first display 11, image data is stored in the video RAM, such that a game image is generated and is outputted to the first display 11. As a result, the game image is displayed on the first display 11.

When the game image is displayed by means of three-dimensional images, the first drawing processing section 111 performs a calculation for converting positions of the objects (for example, the objects constituting the characters, the monsters, or the like) stored in the ROM 102 on the three-dimensional space into positions of them on a pseudo three-dimensional space, an optical source calculation processing, or the like. Further, the first drawing processing section 111 performs a write processing of image data to be drawn on the video RAM based on the calculation result (for example, mapping of texture data to the areas of the video RAM designated by the polygons, or the like). Accordingly, the game image is generated and is outputted to the first display 11. As a result, the game image constituted by three-dimensional image is displayed on the first display 11. The second drawing processing section 112 extracts a predetermined image from the ROM 102 according to the display command. Then, the second drawing processing section 112 stores image data in the video RAM according to a display priority on the second display 12. Accordingly, the predetermined image is generated and is outputted to the second display 12. As a result, the predetermined image is displayed on the second display 12.

In the step S154, when the display command purporting to display the game image is received from the shop server 2 (FIG. 28) (Step S333), the step S155 is performed, such that the game image (see FIG. 30A) is displayed on the first display 11. An image shown in FIG. 30A is an image displayed on the first display 11 of the terminal device 1 that is operated by the player “P1”. This image has a character image P1′ corresponding to the player “P1” and a character image P2′ corresponding to the player “P2”.

In the step S154, when a display command purporting to display a chat button is received from the shop server 2 (FIG. 28) (Step S335), the step S155 is performed, such that the chat button 92 is displayed on the first display 11 (see FIG. 30A). Thus, when the game image including not only one but two or more characters is displayed on the first display 11, the chat button 92 is also displayed thereon. On the lower right side of the image shown in FIG. 30A, the chat button 92 of ‘CHAT’ is disposed. The player contacts the chat button 92 through the touch panel 14 so as to input an instruction purporting to execute a chat.

In the step S154, when a display command purporting to display a chat window is received from the shop server 2 (FIG. 28) (Step S338), the step S155 is performed, such that the chat window 90 (see FIG. 30B) including three chat messages 90a to 90c is displayed on the first display 11. On the lower right of the image shown in FIG. 30B, the chat window 90 including three chat messages 90a to 90c of ‘WHAT ARE YOU DOING?’, ‘WHAT PLACE IS THIS?’, and ‘WHO ARE YOU?’ is disposed. The player contacts any one chat message through the touch panel 14 so as to select a chat message to be transmitted. Then, the player “P1” contacts the character image P2′ corresponding to the player “P2” through the touch panel 14 so as to transmit the selected chat message to the terminal device 1 of the player “P2”.

Further, in the step S154, when a display command purporting to display a chat message is received from the shop server 2 (FIG. 28) (Step S341), the step S155 is performed, such that a chat message 91 (see FIGS. 30C and 30D) is displayed on the first display 11. An image shown in FIG. 30C is an image displayed on the first display 11 of the terminal device 1, which is operated by the player “P1”, when the image shown in FIG. 30B is displayed and when the chat message 90b is selected through the touch panel 14. Near the character image P1′ corresponding to the player “P1”, the chat message 91 of ‘WHAT PLACE IS THIS?’ is displayed. At this time, on the first display 11 of the terminal device 1 operated by the player “P2″ which is the destination of the chat message, an image shown in FIG. 30D is displayed. Near the character image P1′ corresponding to the player “P1”, the chat message 91 of ‘WHAT PLACE IS THIS?’ is displayed. Further, on the lower right side of the screen, the chat window 90 including three chat messages 90d to 90f of ‘IT'S RUINS.’, ‘I DON'T KNOW.’, and ‘NO ANSWER.’ is displayed.

In the step S154, if it is determined that the display command is not received or if the step S155 is executed, the CPU 101 determines whether or not an instruction purporting to execute the chat is inputted (Step S156). This instruction can be inputted when the player contacts the chat button 92 through the touch panel 14. If it is determined that the instruction purporting to execute the chat is inputted, the CPU 101 transmits a chat execution command to the shop server 2 (Step S157). This step corresponds to the step S336 of FIG. 28.

In the step S156, if it is determined that the instruction purporting to execute the chat is not inputted or if the step S157 is executed, the CPU 101 determines whether or not an instruction purporting to select a chat message is inputted (Step S158). This instruction can be inputted when the player contacts any one of three chat messages 90a to 90c included in the chat window 90 through the touch panel 14. At this time, the CPU 101 functions as a message input unit that inputs a message according to the operation of the player.

In the step S158, if it is determined that the instruction purporting to select the chat message is inputted, the CPU 101 stores the selected chat message in the RAM 103 (Step S159). In the step S158, if it is determined that the instruction purporting to select the chat message is not inputted or if the step S159 is executed, the CPU 101 determines whether or not an instruction purporting to select a character which is the destination of the chat message is inputted (Step S160). This instruction can be inputted when the player contacts the character image P2′ through the touch panel 14. At this time, the CPU 101 functions as a selection unit which selects any one character image from the character images included in the game image.

In the step S160, if it is determined that the instruction purporting to select the destination character is inputted, the CPU 101 stores in the RAM 103 destination data representing the terminal device 1 that is the destination of the chat message (Step S161). Next, the CPU 101 transmits the chat message and destination data stored in the RAM 103 to the shop server 2 (Step S162). The CPU 201 of the shop server 2 that receives the chat message and destination data specifies the terminal device 1 serving as the destination based on destination data and transmits the chat message to the terminal device 1 serving as the destination. At this time, the CPU 101 functions as a message transmission unit which transmits the chat message inputted by the CPU 101 serving as the message input unit to the terminal device 1 used by the player who operates the character representing the selected character image by the CPU 101 serving as the selection unit.

In the step S160, if it is determined that the instruction purporting to select the destination character is not inputted or if the step S162 is executed, the CPU 101 refers to the player information (see FIG. 14) stored in the RAM 103 and determines whether or not a predetermined mission completion condition is satisfied (Step S163). As the predetermined mission completion condition, for example, the mission clear, the return to the guild, the life level of the character of zero (0), or the like may be exemplified.

If it is determined that the mission game does not end, the process progresses to the step S150. On the other hand, if it is determined that the mission game ends, the present subroutine ends.

Next, a processing which is executed by the shop server 2 will be described with reference to FIG. 28. First, the CPU 201 determines whether or not the operation command is received from the terminal device 1 (Step S330). If it is determined that the operation command is received, according to that operation command, the CPU 201 updates the player information stored in the RAM 203 (Step S331) and transmits the player information to the terminal device 1 (Step S332). These steps correspond to the step 152 of FIG. 27.

Next, the CPU 201 transmits to the terminal device 1 a display command purporting to cause the first display 11 to display the game image based on the player information (Step S333). This step corresponds to the step S154 of FIG. 27.

In the step S330, if it is determined that the operation command is not received or if the step S333 is executed, the CPU 201 refers to the player information and determines whether or not the character representing any other character is included in the game image displayed on the first display 11 of the terminal device 1 (Step S334). If it is determined that any other character is included, the CPU 201 transmits to the shop server 2 the display command purporting to display the chat button (Step S335). This step corresponds to the step S154 of FIG. 27.

In the step S334, if it is determined that any other character is included in the same game image or if the step S335 is executed, the CPU 201 determines whether or nor a chat execution command is received (Step S336). This step corresponds to the step S157 of FIG. 27. If it is determined that the chat execution command is received, the CPU 201 selects a predetermined number (for example, 3) of chat messages from the chat message list stored in the ROM 202.

FIG. 29 is a diagram showing an example of a chat message list. In the leftmost column, a four-digit number for identifying the chat messages and the chat message corresponding to the number are stored. This represents an initial message. In the column on the right side thereof, for one initial message, three first reply messages are stored. In addition, in the column on the right side thereof, for one first reply message, three second reply messages are stored. The initial message is a message displayed on the first display 11 of the terminal device 1 when the player contacts the chat button 92 through the touch panel 14 and inputs the instruction purporting to execute the chat (see FIG. 30B). The first reply message is a message displayed on the first display 11 of the terminal device 1 that receives the initial message (see FIG. 30D). Further, though not shown in FIGS. 30A to 30D, the second reply message is a message displayed on the first display 11 of the terminal device 1 that receives the first reply message.

After the step S337 is executed, the CPU 201 transmits to the terminal device 1 a display command purporting to display a chat window including the selected chat message through the step S337 (Step S338). This step corresponds to the step S154 of FIG. 27.

In the step S336, if it is determined that the chat execution command is not received or if the step S338 is executed, the CPU 201 determines whether or not the chat message and destination data are received (Step S339). This step corresponds to the step S162 of FIG. 27. In the step S339, if it is determined that the chat message and destination data are received, based on destination data, the CPU 201 specifies the terminal device 1 serving as the destination of the chat message (Step S340) and transmits the display command purporting to display the chat message to the terminal device 1 serving as the destination (Step S341). This step corresponds to the step S154 of FIG. 27.

Next, the CPU 201 refers to the player information (see FIG. 14) stored in the RAM 203 and determines whether or not the predetermined mission completion condition is satisfied (Step S342). If it is determined that the predetermined mission completion condition is not satisfied, the process returns to the step S330. If it is determined that the predetermined mission completion condition is satisfied, the present subroutine ends.

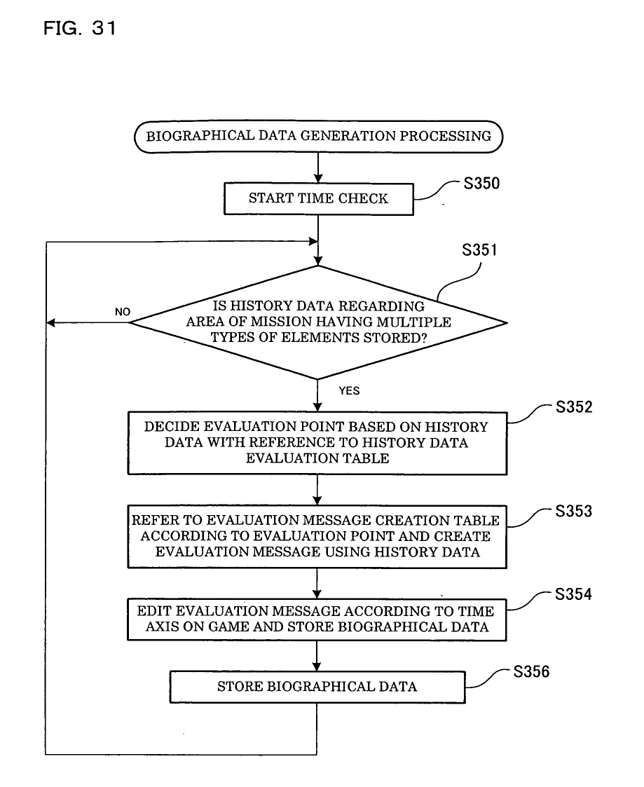

FIG. 31 is a flowchart showing a biographical data generation processing which is executed by the center server 3. This processing is executed when the game according to the present embodiment starts. First, the CPU 301 starts a time check processing for measuring a lapsed time after the game according to the present embodiment starts (Step S350). As for this step, the lapsed time may be measured by setting a timer on the RAM 303 and by counting up the value of the timer sequentially stored in the RAM 303 through a periodic interrupt processing or the like. Further, the timer may be provided in the control section 300. Moreover, in addition to the step S350, the present time may be acquired via Internet at a predetermined cycle.

Next, the CPU 301 determines whether or not game history data (see FIG. 13B) having various kinds of elements regarding the mission clear is stored in the RAM 303 (Step S351). Moreover, when the terminal device 1 executes the step S123 of the subroutine shown in FIG. 15, history data regarding the player who operates the terminal device 1 is transmitted from the shop server 2 to the center server 3 and is stored in the RAM 303. In the step S351, it is determined whether or not history data having various kinds of elements regarding the mission clear exists in history data newly stored in the RAM 303.

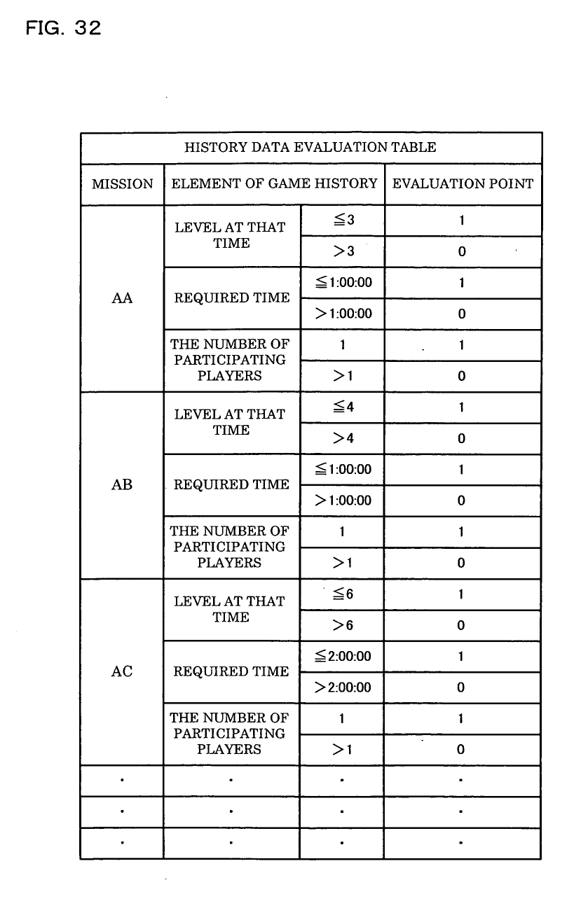

Next, based on game history data (see FIG. 13B) stored in the RAM 303, the CPU 301 refers to a history data evaluation table stored in the ROM 302 and decides an evaluation point (Step S352). FIG. 32 is a diagram showing an example of a history data evaluation table. In the history data evaluation table, for each mission, the elements of game history are correlated with the evaluation point. For example, at the time of the mission “AA”, if the level at that time is equal to or less than 3, the evaluation point one (1) and, if the level exceeds 3, the evaluation point is zero (0). Therefore, when the mission is cleared with the low level, the high evaluation is made. Further, if the required time is within one hour, the evaluation point is one (1) and, if the required time exceeds one hour, the evaluation point is zero (0). Thus, when the mission is cleared at the short time, the high evaluation is made. Further, if the number of participants in the mission is one (1), the evaluation point 1 and, if the number of participants exceeds one (1) (equal to or more than 2), the evaluation point is zero (0). Therefore, when the single mission is selected, the high evaluation is made.

Moreover, referring to the history data evaluation table shown in FIG. 32 based on game history data shown in FIG. 13B, as for the player “DDD”, the evaluation point of the mission “AA” is 2, the evaluation point of the mission “AB” is 1, and the evaluation point of the mission “AC” is 2.

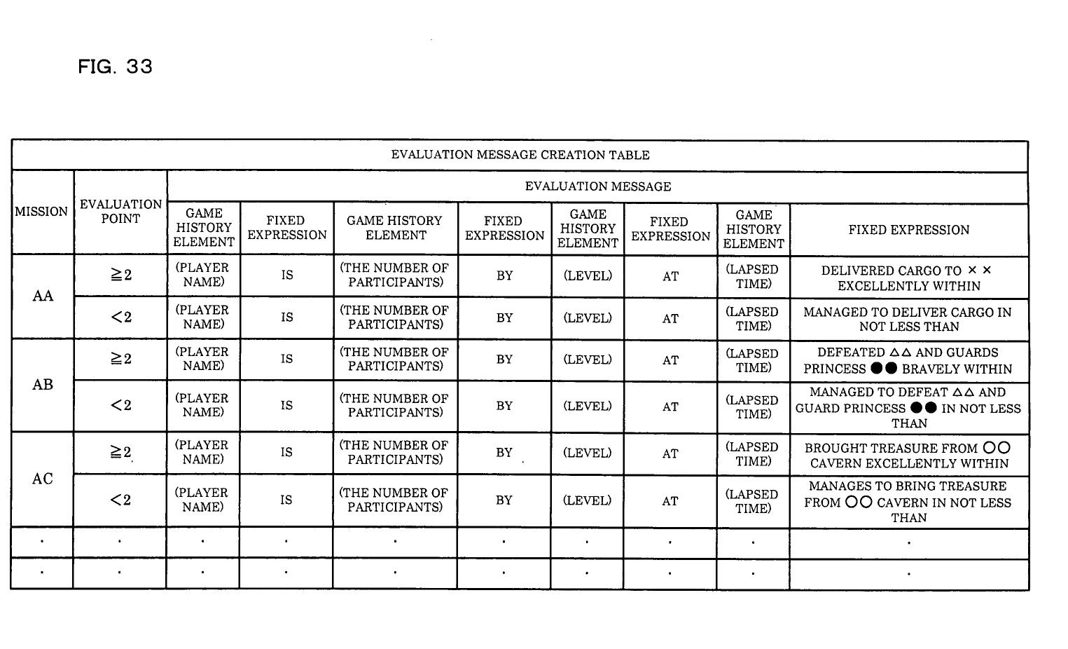

After the step S352, the CPU 301 refers to an evaluation message creation table according to the evaluation point and creates the evaluation message by using history data stored in the RAM 303 (Step S353). FIG. 33 is a diagram showing an example of an evaluation message creation table. In the evaluation message creation table, for each mission, an evaluation message when the evaluation point is equal to or more than 2 and an evaluation message when the evaluation point is less than 2 are stored. Further, each evaluation message has the columns for the elements of game history and fixed expressions alternately arranged therein. The evaluation message is created by inserting the elements of game history into the columns, respectively.

With game history data shown in FIG. 13B, the following evaluation messages are created by referring to the evaluation message creation table shown in FIG. 33. That is, since the evaluation point for the mission “AA” of the player “DDD” is 2, the evaluation message becomes an evaluation message representing a good evaluation of ““DDD” DELIVERED CARGO TO XX PERFECTLY WITHIN “TWO HOURS” BY “HIMSELF” AT “LEVEL 2”’. Further, since the evaluation point for the mission “AB” of the player “DDD” is 1, the evaluation message becomes an evaluation message representing a bad evaluation of ‘“DDD” MANAGED TO DEFEAT ΔΔ AND GUARD PRINCESS ●● IN NOT LESS THAN “TWO HOURS” IN “THREE PERSONS” AT “LEVEL 11”.

After the step S353, the CPU 301 edits the created evaluation message in the step S353 according to the time axis on the game and generates biographical data (Step S354). For example, in the step S35, at the time of creating the evaluation messages for the missions “AA” to “AE” shown in FIG. 13B, in the step S354, since these evaluation messages are edited according to the time axis on the game, the evaluation messages are arranged in an order of the missions “AA”, “AC”, “AD”, “AE”, and “AB”. Next, the CPU 301 stores biographical data in the RAM 303 (Step S356) and the process returns to the step S351.

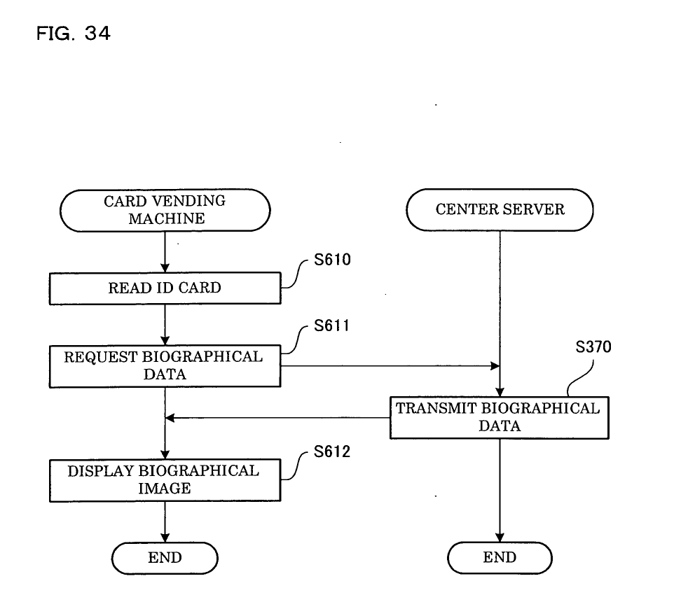

FIG. 34 is a flowchart showing a processing which is executed by the card vending machine 6 and the center server 3 when the biographical image is displayed. First, the CPU 601 reads ID data of the player from the ID card 8 by means of the ID card reader 616 (Step S610). The CPU 601 that reads ID data from the ID card 8 by means of the ID card reader 616 transmits to the center server 3 a request signal purporting to request biographical data corresponding to this ID data via the private line 5 by means of the communication interface circuit 604 to pass through the shop server 2 (Step S611). When receiving the request signal, the CPU 301 of the center server 3 extracts biographical data according to the ID data from biographical data stored in the RAM 303 (biographical data stored in the RAM 303 in the step S356 of FIG. 31) and transmits that biographical data to the card vending machine 6, which is the source of the request signal (Step S370). Further, image data representing the content of image data may be extracted from the ROM 302, in addition to biographical data, and is transmitted, together with biographical data.

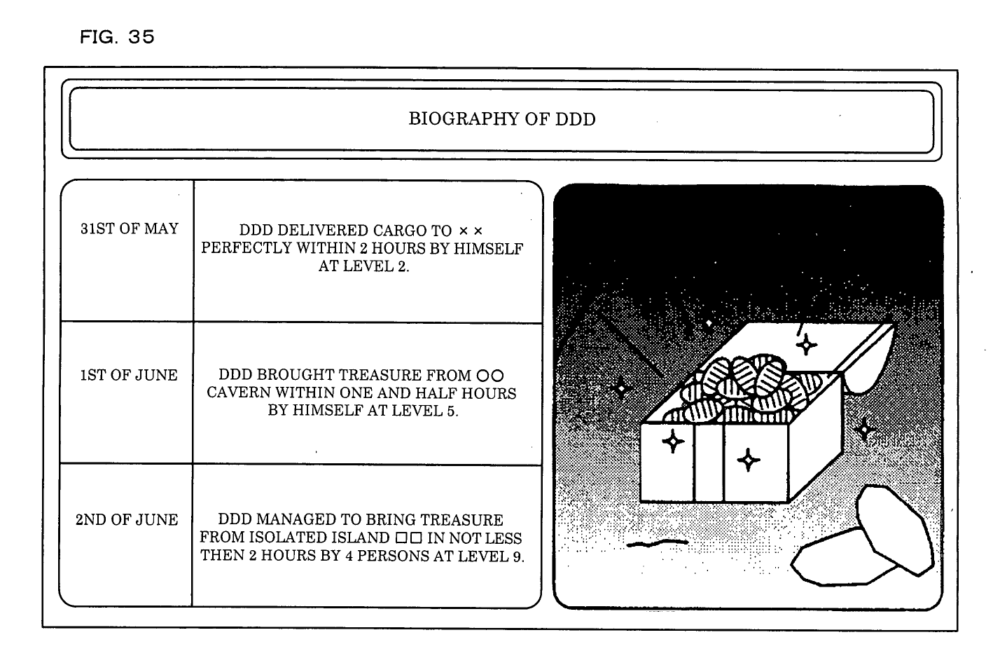

The CPU 601 of the card vending machine 6 that receives biographical data from the center server 3 causes the display 61 to display a biographical image shown in FIG. 35 by means of the drawing processing section 611 based on that biographical data (Step S612) and the present subroutine ends.

FIG. 35 is a diagram showing an example of a biographical image displayed on the display 61 of the card vending machine 6 when the processing of FIG. 34 is executed. On the upper side of the screen, an image of ‘BIOGRAPHY OF DDD’ is disposed. Further, on the left side of the screen, the biographical image that represents biographical data in table is disposed. Specifically, each of the evaluation messages regarding the mission clear is disposed in correlating with the date when the mission is cleared. Further, on the right side of the screen, an image representing the content of biographical data is disposed.

As described above, according to the game system of the present embodiment, the player selects the character image included in the game image so as to specify the player as the destination and to transmit the message. Thus, with the communication with the specified player, it is possible to construct the friendship and to exchange the beneficial information with the specified player. Further, if the character image included in the game image is selected, it is possible to specify the player serving as the destination of the message, and thus the operationality can be enhanced.

In the invention, like the present embodiment, each of the multiple terminal devices 1 has the touch panel 14 that provided in front of the display unit (the first display 11) and can detect the contact by the player to output the detection signal representing the contact position when the contact is detected. The selection unit (CPU 101) preferably selects the character image displayed at the display position that matches with the contact position represented by the detection signal outputted from the touch panel 14. While performing the movement or attack operation of the character by means of various buttons 118 or the operating lever 119, the player contacts the character image through the touch panel 14 so as to specify the player serving as the destination of the message, thereby rapidly enhancing the operationality.

The selection of character may be performed as follows. When, in the game image, one character corresponding to one player comes in contact with another character, the another character may be selected as to receive the message inputted by the one player. In this case, an operation only for specifying the player serving as the destination of the message can be omitted. In other words, a player can specify another player serving as the destination of the message not through the touch panel 14 but through the buttons 118 or the operating lever 119 which is used for moving the character in the game image. Thus, the operationality can be more enhanced. Further, in this case, a message is transmitted when characters come in contact with each other in the game image, thereby enhancing the feeling of being at a live performance as if the players actually have a conversation.

In the present embodiment, the case, in which three chat messages are selected according to the progress status of the game or chat from the chat message list (see FIG. 29) in which various kinds of chat messages are stored, the chat window including three chat messages is displayed, and one message to be transmitted from them is selected. In the invention, however, one message to be transmitted from all chat messages included in the chat message list (all predetermined chat messages) may be selected. Further, the terminal device 1 may have a message input unit such as a keyboard, such that the player may create and input messages freely through the message input unit. Further, the game system of the invention may be constructed such that the RAM 203 of the shop server 2 stores the chat message, which is communicated during the mission game, as the input completion message and the input completion message is read on the guild board. For this reason, multiple players can provide the information for the chat to the many and unspecified players, regardless of the chat time. Further, the many and unspecified players who participate in the game can read the information provision, regardless of the reading time, thereby further urging the chat between the players.

Further, in the present embodiment, since the message is stored in the RAM 203 of the shop server 2 (Step S3332), the communication at different points of time among the players can be achieved. That is, the players can exchange information with one another, even when they do not participate in the game simultaneously.

Further, the messages, which can be inputted by the player on the guild board, are stored in the ROM 202 as a message list (see FIG. 23) and the messages to be inputted are limited to the messages included in that list. Thus, when many and unspecified participants send information, information against public order and standards decency caused can be prevented from being sent.

In the above embodiment, the game system having the multiple terminal devices 1, the shop servers 2 that are communicatably connected to the multiple terminal devices 1 via the private line 5, and the center server 3 that is communicatably connected to the multiple shop servers 2 via the communication line 4 is described. However, the invention is not limited to this example.

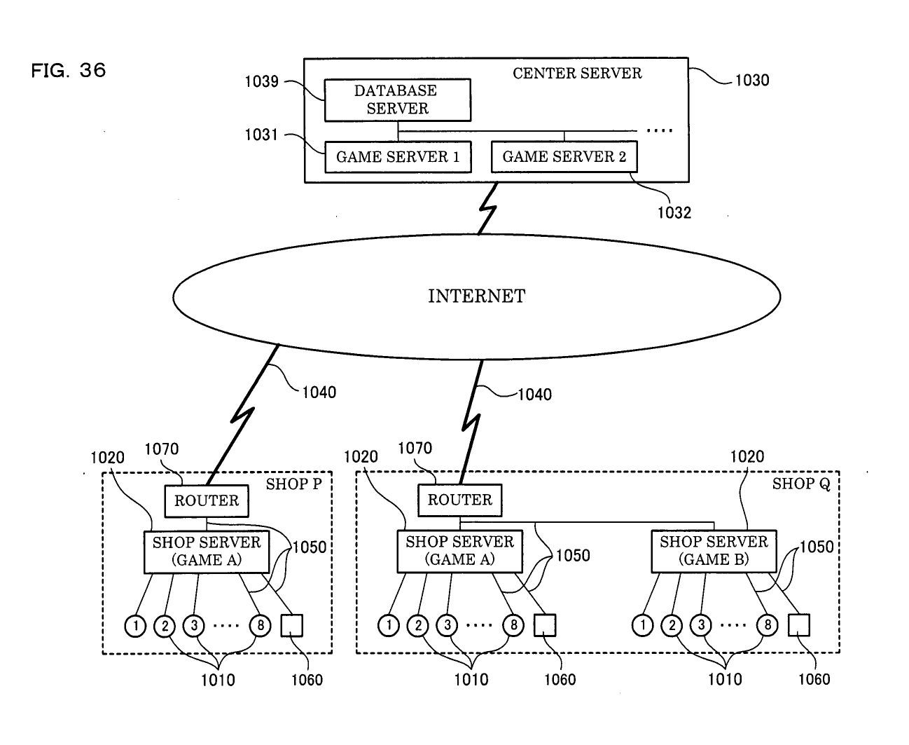

Here, another example of a game system according to the invention will be described. FIG. 36 is a diagram showing a configuration of a game system according to the invention, as another example. The game system shown in FIG. 36 has multiple terminal devices 1010, shop servers 1020 that are communicatably connected to the multiple terminal devices 1010 via the private lines 1050, and a center server 1030 that is communicatably connected to the multiple shop servers 1020 via a communication line 1040. Further, the game system has a card vending machine 1060 that is connected to the shop server 1020 via the private line 1050 for each shop. Moreover, in the shop Q, a shop server 1020 for a game A and a shop server 1020 for a game B are disposed.

The center server 1030 has a database server 1039 and multiple game servers 1031, 1032, . . . . The database server 1039 performs (1-1) the data management for each ID data imparted to each player, (1-2) the authentication at the time of the game start, and (1-3) the transmission of game data.

Specifically, as for the above-described (1-1), the database server 1039 manages (stores, sets, updates, or the like), for example, ID data imparted to the player, the password that is used for the authentication of the player, the kind of the game played by the player, and game data. Further, game data includes, for example, the game progress status (character unique data, or the like), the character operated by the player, the level value or ability of that character, the increase of the ability, or the like.

As for the above-described (1-2), the database server 1039 performs the authentication of the player by using, for example, the ID data and password and permits to participate in the game. In addition, as for the above-described (1-3), the database server 1039 transmits character data from the game data to the terminal device 1010, for example, based on ID data of the player.

The game servers 1031, 1032, . . . . are disposed to correspond to games to be executable on the game system according to the present embodiment. Moreover, one of the multiple game servers is the game server corresponding to the game according to the present embodiment. The game servers 1031, 1032, . . . (hereinafter, referred to as the game server 1031 and the like) performs (2-1) the mapping processing between the terminal devices 1010 which are disposed at different shops and (2-2) the traffic regulation regarding the data communication after mapping.

Specifically, as for the above-described (2-1) or when the player participates in the game by operating the terminal device 1010, the game server 1031 and the like determines whether or not other players participate in the game. Then, if it is determined that other players participate in the game, the mapping of the terminal device 1010 operated by that player. On the other hand, when it is determined that other players do not participate in the game, a CPU player is set. When the CPU player is set, the shop server 1020 may be set as the CPU player or the center server 1030 (for example, the game server 1031 and the like) may be set to the CPU player.

Further, as for the above-described (2-2), the game server 1031 and the like performs the traffic regulation regarding the data communication among the terminal devices 1010 that are mapped through the mapping processing of the above-described (2-1). For example, the game server 1031 and the like transmit data received from the terminal device 1010 connected to the shop server (for the game B) 1020 of the shop P to the terminal device 1010 connected to the shop server (for the game A) 1020 of the shop Q. As such, the shop server 1020 according to the present embodiment directly receives data from only the center server 1030, while the direct data communication is not performed among the shop servers 1020.

The shop server 1020 is connected to the center server 1030 via a router 1070. The router 1070 has a predetermined routing table. Like the shop Q shown in the drawing, when the multiple shop servers 1020 are provided in the same shop, the router 1070 receives game data or the like from the center server 1030 and transmits that game data to the shop server 1020 that is connected to the terminal device 1010 serving as the destination via the private line 1050. Further, when the data communication is performed among the terminal devices 1010 that are connected to the multiple shop servers 1020 provided in the same shop, the router 1070 receives game data or the like from the terminal device 1010 through the shop server 1020 and transmits that game data to the shop server 1020, that is connected to the terminal device 1010 serving as the destination via the private line 1050, with reference to the routing table.

The shop server 1020 performs (3-1) the traffic regulation regarding the data communication between the center server 1030 and the terminal device 1010 or among the terminal devices 1010 connected to the multiple shop servers 1020 that are provided in the same shop and (3-2) the download of an application to the terminal device 1010.

Specifically, as for the above-described (3-1), the shop server 1020 performs the traffic regulation regarding the communication of game data or the like between the center server 1030 and the terminal device 1010. However, when the terminal device 1010 serving as the destination is connected to the same shop server 1020 or is connected to another shop server 1020 which is provided in the same shop, game data or the like is not transmitted to the center server 1030. In this case, the data communication is performed to the terminal device 1010.

Further, as for the above-described (3-2), at the timing when a request signal purporting to request for the download from the center server 1030 is received from the terminal device 1010, the shop server 1020 downloads the application to that terminal device 1010. The application includes various data regarding the game content (for example, image data or the like) and program, and a board program that allocates the functions on the game to the input unit (for example, multiple input switches or the like (not shown)) provided in the terminal device 1010. Further, the download of the application is not limited to the download from the shop server 1020. Alternatively, the download may be performed from the center server 1030.

The terminal device 1010 is connected to the shop server 1020 via the private line 1050. The terminal device 1010 performs (4-1) the download of the application and (4-2) the progress of the game. Specifically, as for the above-described (4-1), when power is supplied, the terminal device 1010 transmits a request signal purporting to request for the download of the application to the shop server 1020 and performs the download of the application. The downloaded application is stored in a temporarily storage area of the RAM or the like in the terminal device 1010. Further, as for the above-described (4-2), the terminal device 1010 performs the progress of the game with the downloaded application. The progress of the game is performed as follows. The terminal device 1010 receives data for each ID data imparted each player from the database server 1039 at the time of the game start. During the progress of the game, data of the terminal device 1010 and another terminal device 1010 in the same game is communicated via the shop server 1020 to pass through the center server 1030. However, when another terminal device 1010 is connected to the same shop server 1020 or is connected to another shop server 1020 provided in the same shop, game data or the like is not transmitted to the center server 1030. That is, the game data or the like is transmitted to the terminal device 1010. At the time of the game end, game data updated during the game or the game result itself is transmitted to the database server 1039. Moreover, the progress of the game may be performed by the shop server 1020, in addition to the terminal device 1010.

The card vending machine 1060 is communicatable with the center server 1030 via the shop server 1020. The card vending machine 1060 receives the input operation of individual information by the player and sells the ID card in which ID data is stored. The ID card is used when the game starts and ID data is read out by an ID card reader provided in the terminal device 1010.

In this embodiment, the first drawing processing section provided in the terminal device 1010 functions as an image display unit that causes the first display serving as a display unit to display the game image including the character images representing the characters. The CPU provided in the terminal device 1010 functions as a selection unit that selects any one character image from the character images included in the above-described game image. The CPU provided in the terminal device 1010 functions as a message input unit that inputs a message according to the operation of the player. The CPU provided in the terminal device 1010 functions as a message transmission unit that transmits the message inputted by the message input unit to the terminal device 1010 used by the player who operates the character represented by the character image selected by the above-described selection unit. Moreover, when the terminal device 1010 serving as the destination is connected to the same shop server 1020, the CPU of the terminal device 1010 functioning as the message transmission unit transmits the message to the terminal device 1010 serving as the destination not to pass through the game server 1031 and the like of the center server 1030. On the other hand, when the terminal device 1010 serving as the destination is connected to a different shop server 1020, the CPU of the terminal device 1010 functioning as the message transmission unit transmits the message to the terminal device 1010 serving as the destination to pass through the game server 1031 and the like of the center server 1030.

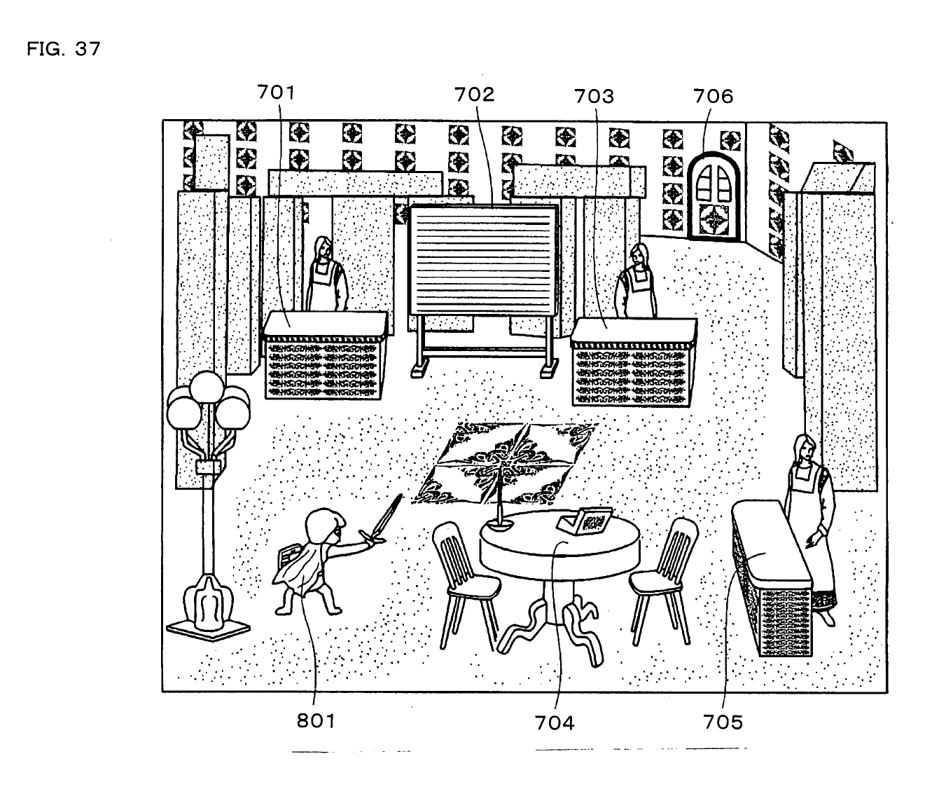

Next, a game system according to another embodiment of the invention will be described with reference to FIG. 37. The game system according to the present embodiment has the substantially same configuration as that of the above-described embodiment, and thus only the difference will be described below.

In the present embodiment, when the guild execution processing is executed, an image schematically representing the room of the guild shown in FIG. 37 is displayed on a first display 11 by means of a first drawing processing section 111, instead of the image shown in FIG. 17A or 17B. On an upper left side of the screen, a display representing ‘room of guild’ is made. In the room of guild, an object 701 representing ‘mission reference/acceptance window’, an object 702 representing ‘board’, an object 703 representing ‘reward reception window’, an object 704 representing ‘information collection space’, an object 705 representing ‘belonging selling window’, an object 706 representing ‘mission start exit’ are arranged. (The arrangement of these objects is not limited to that shown in the drawing. For example, these objects may be arbitrarily arranged.) Further, the character 801 representing the player is disposed near an entrance (not shown) in an initial stage of the guild execution processing. The player can arbitrarily move the character 801 representing him by operating the operating lever 119 of the game terminal 1. The determination of ‘whether or not a mission reference/acceptance instruction is inputted’, ‘whether or not a board use instruction is inputted’, ‘whether or not a reward payment request instruction is inputted’, ‘whether or not an information collection instruction is inputted’, ‘whether or not a belonging selling instruction is inputted’, or ‘whether or not a mission start instruction is inputted’, is performed according to whether or not the hit judgment between the object representing the mission reference/acceptance window, the board, the reward payment window, the information collection space, the belonging selling window, or the mission start exit, and the character representing to the player is made.

The guild execution processing routine shown in FIG. 16 according to the present embodiment will be described.

In a step S130, when the hit judgment is made by the relationship between the character 801 representing the player and the mission reference/acceptance window object 701, the CPU 101 determines that the mission reference/acceptance instruction is inputted.

If the player accepts the mission, the CPU 101 changes the portion ‘mission reference/acceptance’ shown in FIG. 21B to ‘mission start’ in the mission reference/acceptance processing (Step S131).

In a step S132, the CPU 101 performs a comparison processing of image data of the character and image data of the board object 702 according to the operation of the player via the game terminal 1 with the positional relationship between the character 801 representing the player and the board object 702 and, when it is determined that the character 801 and the board object 702 come in contact with each other, determines that the board use instruction is inputted. At this time, the CPU 101 functions as a position determination unit that determines whether or not the character is positioned at a predetermined position.

In a step S134, the CPU 101 determines that the reward payment request instruction is inputted when the hit judgment is made by the relationship between the character 801 representing the player and the reward reception window object 703.

In a step S136, the CPU 101 determines that the information collection instruction is inputted when the hit judgment is made by the relationship between the character 801 representing the player and the information collection space object 704.

In a step S138, the CPU 101 determines that the belonging selling instruction is inputted when the hit judgment is made by the relationship between the character 801 representing the player and the belonging selling window object 705.

In a step S140, after the mission acceptance processing, the CPU 101 determines that the mission start instruction is inputted when the hit judgment is made by the relationship between the character 801 representing the player and the mission start exit object 706.

As described above, according to the game system of the present embodiment, the player operates the character representing him and input the message at the moment that the character 801 comes in contact with the board object 702, thereby enhancing the feeling of being at a live performance as if the player actually performs a writing operation on the board.

Similarly, the board admission is made at the moment that the character comes in contact with the object representing the board, thereby enhancing the feeling of being at a live performance as if the player actually sees the board.

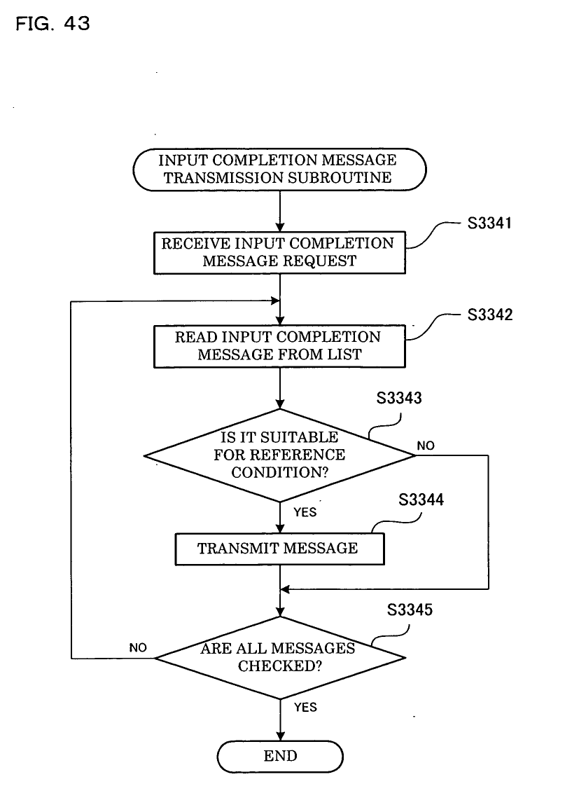

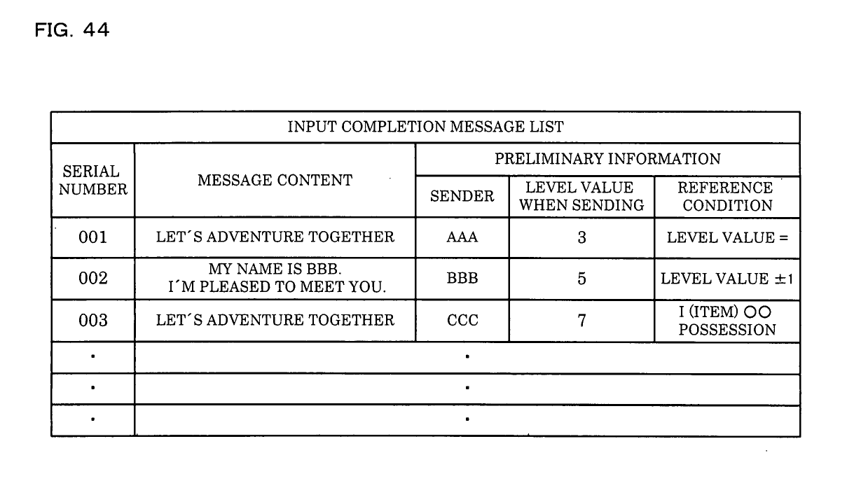

Further, as still another embodiment, the message according to the game history of each player may be selectively transmitted. This embodiment will be described below with reference to FIG. 43. FIG. 44 shows a summary of an input completion message list which is transmitted from the respective terminal devices to the shop server in advance and which is stored in the RAM 203. “The reference condition” on the table of FIG. 44, which is provided to limit players capable of receiving a message, is based on a game history of a player who inputted a message. The reference condition may be set by a player and otherwise preset.

In a step S3341 of FIG. 43, the shop server 2 which receives the input completion message request from the game terminal sequentially reads the respective messages from the input completion message stored in the RAM 203 in advance (Step S3342). Then, the shop server 2 compares game history information of the player, who requests the message, similarly, stored in the RAM 203, to the reference condition stored in preliminary information of each message and determines whether or not the history information of the player who requests the message matches with the reference condition (Step S3343). For example, referring to FIG. 14, when the player CCC requests the input completion message from the game terminal b1 under operation, as seen from FIG. 44, the message of the serial number 001 is transmitted since it satisfies the reference condition (the same level) (Step S3344), while the messages of the serial numbers 002 and 003 are not transmitted since they do not satisfy the reference condition.

The reference condition is not limited to the level of the player who requests the message. For example, the message may be transmitted to only the player who possesses a specified item, as in the serial number 003 shown in FIG. 44.

It is determined whether or not the reference condition is satisfied for each player (Step S3342). If all messages are checked (Step S3345: YES), the present subroutine ends. If there is a message which is not checked (Step S3345: NO), the message from the list is called again and the routine is performed repeatedly.

As such, there is no case in which the message inputted by each player is indiscriminately transmitted to all players. Further, the information exchange can be performed according to the level or the state of the game progress of each player. As a result, the player can be prevented from losing interest in the game due to overflowing of the information. Further, as in the serial number 003 shown in FIG. 44, the message can be transmitted to only the player who possesses the specified item, such that the story can have the expanse.

In addition, in a step S3330 of the board use processing shown in FIG. 22, the shop server 2 may transmit any one of message image data and source data, which is required for displaying the board image on the terminal device 1, as message data. When a drawing program, texture image information serving as drawing source image data, mapping information, and the like are stored in the terminal device 1, source data means vertex information for arranging multiple objects in a three-dimensional space, coordinate data of an object arranged in a two-dimensional space, identification information of an arranged character image, and the like. When source data is transmitted, it has an advantage in that the amount of communication data becomes small, as compared to the case in which message image data is transmitted.

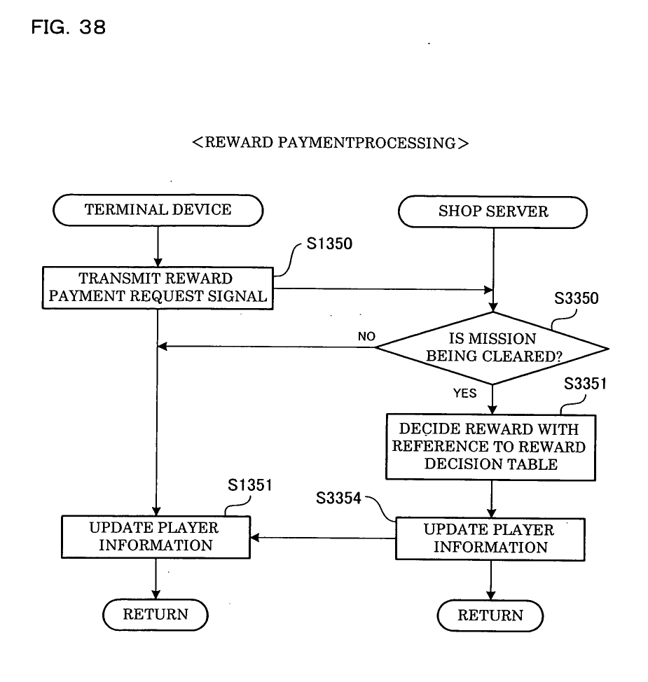

The reward payment processing, which is executed at the step S135 shown in FIG. 16, is not limited to the processing shown in FIG. 25, but may be the processing shown in FIG. 38. In FIG. 38, steps S3352 and S3353 shown in FIG. 25 are omitted.

In a step S3351 shown in FIG. 38, a CPU 201 of the shop server 2 decides the reward based on the kind of the cleared mission, the level of the player, and the mission acceptance format (the number of mission participants).

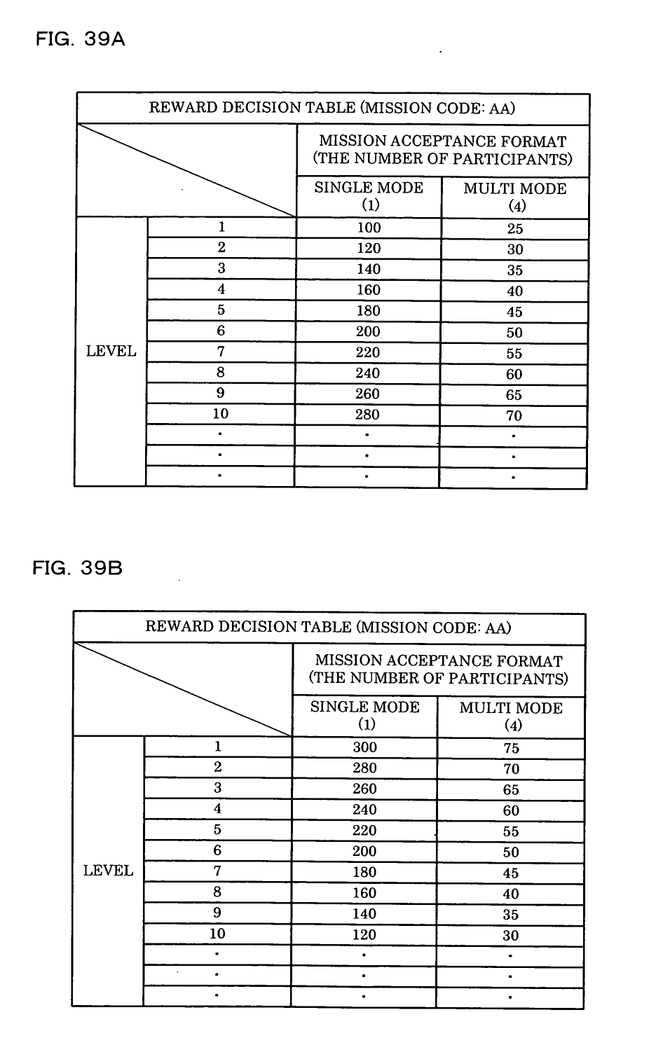

FIGS. 39A and 39B show examples of a reward decision table which is different from that shown in FIG. 26, respectively. FIG. 39A is a diagram showing an example of a reward decision table for the mission “AA”. The reward decision table is stored in the ROM 202 of the shop server 2 as data. Moreover, the example of the reward decision table for the mission “AA” is described herein, but, similarly, reward decision tables for other missions are stored in the ROM 202 as data.

In the reward decision table shown in FIG. 39A, the reward is correlated with the combination of the level of the player (the character corresponding to the player) and the mission acceptance format (the number of mission participants). For example, when the level of the player is 1 and the mission acceptance format is a single mode, the reward becomes 100.

Further, in the reward decision table shown in FIG. 39A, even when the same mission (here, the mission “AA”) is cleared, the higher the level of the player is, the higher the reward is. For example, when the mission acceptance format is the single mode, if the level of the player is increased in an order of 1, 2, 3, . . . , the reward is increased in an order of 100, 120, 140, . . . accordingly.

Therefore, when the reward is decided with reference to the reward decision table shown in FIG. 39A, even in a low-difficulty mission, a high-level player can receive the reward more than a low-level player receives, as the game result.

In addition to the reward decision table shown in FIG. 39A, for example, the reward may be decided with reference to the reward decision table shown in FIG. 39B. FIG. 39B is a diagram showing another example of a reward decision table for the mission “AA”.

In the reward decision table shown in FIG. 39B, like FIG. 39A, the reward is correlated with the combination of the level of the player (the character corresponding to the player) and the mission acceptance format (the number of mission participants). However, the correlated reward is different from that in the reward decision table of FIG. 39A. That is, in the reward decision table shown in FIG. 39B, even when the same mission (here, the mission “AA”) is cleared, the higher the level of the player is, the lower the reward is. For example, when the mission acceptance format is the single mode, if the level of the player is increased in an order of 1, 2, 3, . . . , the reward is decreased in an order of 300, 280, 260, . . . , accordingly.

Therefore, when the reward is decided with reference to the reward decision table shown in FIG. 39B, even if the same mission is cleared, the high-level player cannot but receive the reward smaller than the low-level player receives, as the game result.

After the step S3351, the CPU 201 skips over the steps S3352 and S3353 shown in FIG. 25 and progresses to a step S3354.

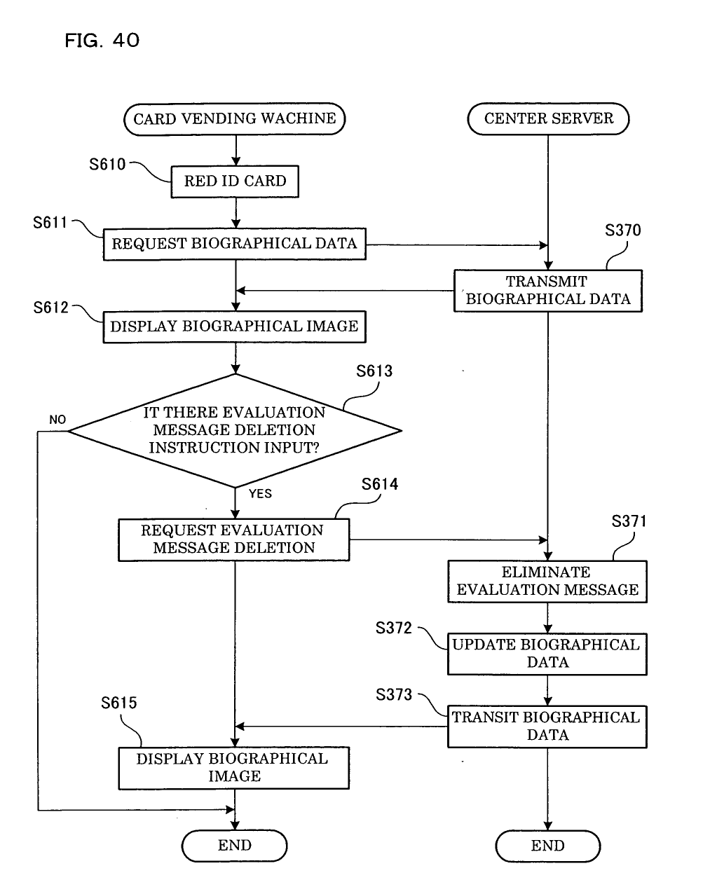

Further, a processing which is executed by a card vending machine 6 and a center server 3 when the biographical image is displayed is not limited to that shown in FIG. 34, but, may be a processing shown in FIG. 40. In FIG. 40, steps S613 to S615 are added after a step S612 by the card vending machine 6 in FIG. 34 and steps S371 to S373 are added after a step S370 by the center server 3 in FIG. 34.

After the step S612, the present subroutine does not end and continuously, it is determined whether or not an instruction purporting to delete the evaluation message is inputted through the operation of the player (Step S613). This instruction can be inputted through the operation of an operating button 618 of the card vending machine 6 by the player. If it is determined that the instruction purporting to delete the evaluation message is not inputted, the present subroutine ends.

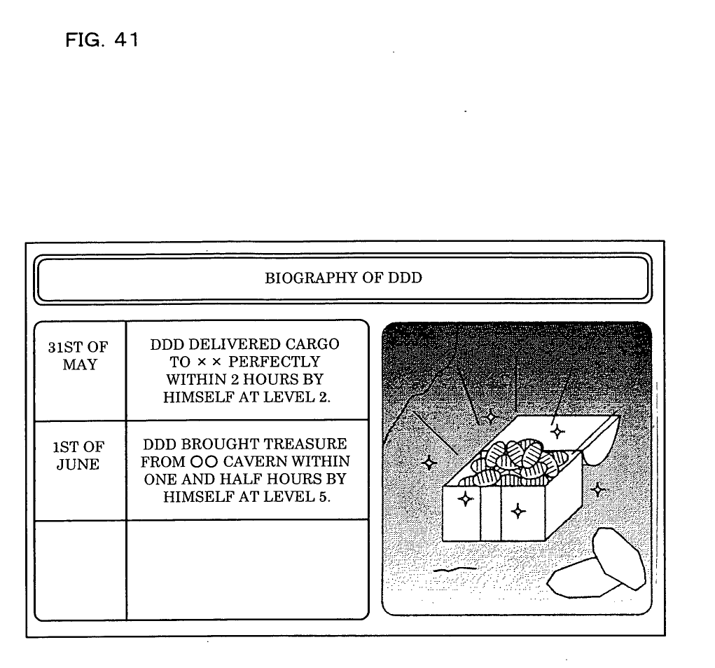

On the other hand, if it is determined that the instruction purporting to delete the evaluation message is inputted, the CPU 601 transmits a request signal purporting to delete the evaluation message to the center server 3 (Step S614). When receiving the request signal, a CPU 301 of the center server 3 performs a processing of deleting the evaluation message from the ROM 303 based on the request signal (Step S371). Next, the CPU 301 updates biographical data stored in the RAM 303 based on the processing result of the step 371 (Step S372) and transmits updated biographical data to the card vending machine 6 (Step S373). When receiving updated biographical data from the center server 3, the CPU 601 of the card vending machine 6 displays a biographical image shown in FIG. 41 on a display 61 by means of a drawing processing section 611 based on biographical data (Step S615).

FIG. 41 shows a biographical image displayed on the display 61 when an instruction purporting to delete a lowermost evaluation message (evaluation message representing low evaluation) is inputted in a state in which the biographical image shown in FIG. 35 is displayed on the display 61 of the card vending machine 6. That is, in FIG. 41, the lowermost evaluation message of FIG. 35 is deleted.

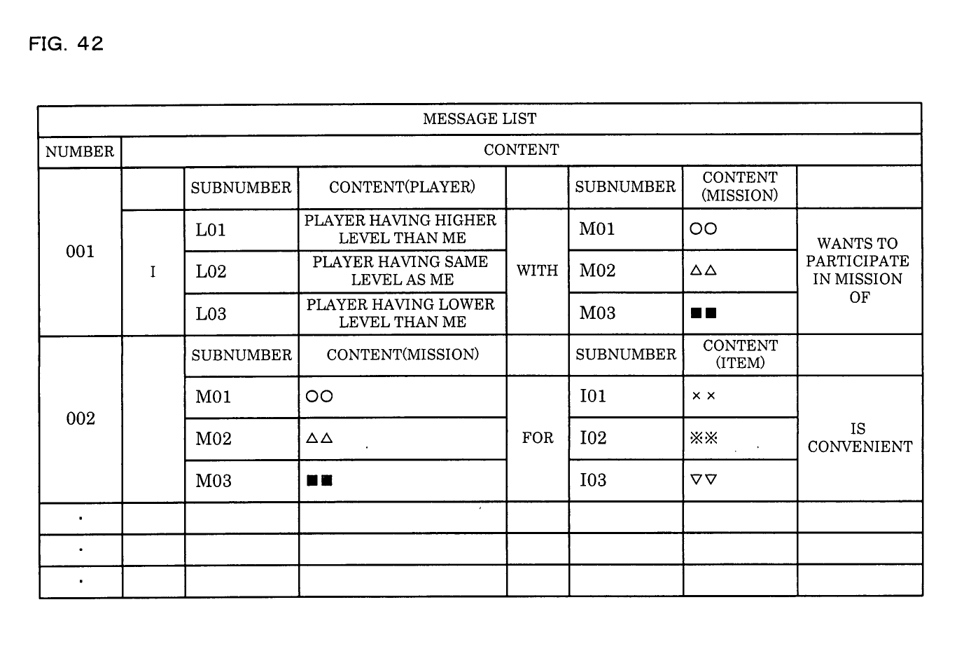

The message list is not limited to that having a fixed expression format shown in FIG. 23. For example, a message list having an element selection supplement format shown in FIG. 42 may be used. When a player wants to participate in a mission ‘OO’ together with any other high-level player, the number ‘001’ of the message list is selected and the subnumbers ‘L01’ and ‘M01’ are selected. Then, a message ‘I wants to participate in the mission OO together with any other high-level player’ can be inputted.

In the above-described embodiment, a case in which the board is disposed in the guild is described. However, the invention is not limited to the embodiment. For example, the board may be disposed in a game space during the mission game execution. For example, the object representing the board may be provided near an entrance of a dungeon (underground maze) and the message input may be permitted at the moment that the hit judgment of this object and the character is made.

The game image displayed on the first display 11 is not necessarily a three-dimensional image. A two-dimensional image in which characters or all kinds of objects are disposed with coordinate data on a planar coordinate applied thereto.

As an example of the terminal device, an office game device having two displays (first display 11 and second display 12) is described. However, the invention can be applied to a home video game device in which a home video game device is connected to a home television, a personal computer which executes a video game program to function as a video game device, or the like.

As for the terminal device 1, a case in which an input unit, through which the player inputs an instruction, has a touch panel 14, various buttons 118, and an operating lever 119 is described. However, the input unit may be constructed by only the touch panel 14 or may be constructed by only various buttons 118 and the operating lever 119. Further, as the input unit, for example, a well-known keyboard, a mouse, a pointing device, or the like may be adopted.

In the above-described embodiment, a case in which the ROM 202 of the shop server 2 stores a chat message list is described. However, for example, the ROM 102 of the terminal device 1 may store the chat message list.

Elements of any one of the terminal device 1, the shop server 2, and the center server 3 may function as the respective units according to the invention. For example, in the above-described embodiment, the first display 11, the CPU 101, and the keyboard of the terminal device 1 function as a display, a selection unit and a message transmission unit, and a message input unit, respectively. Alternatively, the respective elements of the shop server 2 or the center server 3 may function as the above-described units.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A game system in which a plurality of terminal devices, each having a display unit, and a server are connected via a communication line and in which a plurality of players operates characters corresponding to the respective players by using the respective terminal devices to play a game, comprising:
an image display control unit for causing the display unit to display a game image including the characters;
a selection unit, according to an operation of a player, selecting any one of characters corresponding to other players than the player, who performs the operation, from among the characters included in the game image;
a message input unit for inputting a message according to an operation of the player; and
a message transmission unit for transmitting the message inputted by the message input unit to a terminal device used by a player who operates the character selected by the selection unit.

2. The game system according to claim 1, wherein:
each of the plurality of terminal devices has a touch panel that is provided in front of the display unit and detects a contact by a player to output a detection signal representing a contact position when the contact is detected; and
the selection unit selects a character displayed at a display position which matches with the contact position represented by the detection signal outputted from the touch panel.

3. The game system according to claim 1, wherein:
the image display control unit causes the display unit to display the game image such that a character corresponding to a player moves according to an operation of the player; and
the selection unit selects another character with which the character moved according to the operation of the player comes in contact.

4. The game system according to claim 2, wherein:
the image display control unit causes the display unit to display a message input command button formed on the touch panel and, when a player touches the message input command button, to display a plurality of selectable message buttons respectively indicating different messages and formed on the touch panel; and
the message input unit inputs a message indicated by one of the massage buttons touched by the player.

5. A game system in which a plurality of terminal devices, each having a display unit, and a server are connected via a communication line and in which a plurality of players operates characters corresponding to the respective players by using the respective terminal devices to play a game, comprising:
an image display control unit for causing the display unit to display a game image including the characters and for causing the display unit to display the game image such that a character corresponding to a player moves according to an operation of the player;
a message input unit provided in each of the terminal devices for inputting a message according to an operation of the player;
a first position determination unit for determining whether or not any one of the characters is at a first position;
an input permission unit for, when the first position determination unit determines that one character is at the first position, permitting the massage input unit of a terminal device used by a player, who operates the character, to input a message via the communication line; and
a message storage unit provided in the server for storing the message inputted by the massage input unit, which is permitted to input the message by the input permission unit.

6. The game system according to claim 5, comprising:
an input request reception unit provided in the server for receiving a message input request from the terminal device; and
an input permission information transmission unit provided in the server for transmitting one or a plurality of pieces of input permission information stored in the message storage unit to the terminal device from which the message input request is received by the input request reception unit.

7. The game system according to claim 5, further comprising:
a second position determination unit for determining whether or not any one of the characters is at a second position; and
a message image data transmission unit for, when the message is stored in the message storage unit and when the second position determination unit determines that one character is at the second position, transmitting one of message image data including the message stored in the message storage unit to a corresponding terminal device.

8. The game system according to claim 7, further comprising:
a game history storage unit provided in the server for, whenever a player progresses the game, updating a game history of the player and storing the updated game history in the memory of the server;
a correlation unit for, when the message storage unit stores the message, correlating the message with a transmission condition which is based on a game history of a player who uses a terminal device having the message input unit permitted to input the message; and
a message transmission/rejection decision unit for, when the second position determination unit determines that one character is at the second position, comparing a game history of a player who operates the character and the transmission condition correlated with the message by the correlation unit and deciding whether or not the message image data transmission unit transmits data.

9. The game system according to claim 7, wherein the first and second positions are identical.

10. A game system in which a plurality of terminal devices, each having a display unit, and a server are connected via a communication line and in which a plurality of players operates characters corresponding to the respective players by using the respective terminal devices to play a game, comprises:
an image display control unit for causing the display unit to display a game image including the characters and for causing the display unit to display the game image such that a character corresponding to a player moves according to an operation of the player;
a message input unit provided in each of the terminal devices for inputting a message according to an operation of the player;
a third position determination unit for determining whether or not any one of the characters is at a third position;
a message storage unit provided in the server for storing the message inputted by the massage input unit; and
message image data transmission unit for, when the message is stored in the message storage unit and when the third position determination unit determines that one character is at the third position, transmitting one of message image data including the message stored in the message storage unit to a corresponding terminal device.

11. The game system according to claim 10, further comprising:
a game history storage unit provided in the server for, whenever a player progresses the game, updating a game history of the player and storing the updated game history in the memory of the server;
a correlation unit for, when the message storage unit stores the message, correlating the message with a transmission condition which is based on a game history of a player who uses a terminal device having the message input unit permitted to input the message; and
a message transmission/rejection decision unit for, when the second position determination unit determines that one character is at the second position, comparing a game history of a player who operates the character and the transmission condition correlated with the message by the correlation unit and deciding whether or not the message image data transmission unit transmits data.
